(19) United States
(12) Patent Application Publication
(10) Pub. No.: US 2007/0048474 A1
(43) Pub. Date: Mar. 1, 2007

(54) Dispensing paper-roll core systems

(75) Inventors: George Henry Butler III, Mesa, AZ (US); Donald Joseph Berg, Escondido, CA (US); Brian Barnett Scanlan, Gilbert, AZ (US); Scott Thomas Yee, Chandler, AZ (US); James Kevan Guy, Mesa, AZ (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/515,254

(22) Filed: Sep. 1, 2006

Related U.S. Application Data
(63) Continuation-in-part of application No. 10/948,602, filed on Sep. 23, 2004.
(60) Provisional application No. 60/715,833, filed on Sep. 9, 2005.
(60) Provisional application No. 60/750,904, filed on Dec. 16, 2005.

(51) Int. Cl. B29C 47/00

(52) U.S. Cl. 428/36.9

(57) ABSTRACT

A paper-roll core that is a soluble, disposable carrier for cleaning and/or disinfecting chemicals. The paper-roll cores are toilet paper roll cores and paper towel roll cores and are rapidly soluble in water and may release cleansers, disinfectants, colors, etc., upon dissolving. Described are: methods of using, manufacturing, advertising, and distributing the paper-roll cores; and methods of advertising and distributing such paper-roll cores to children, who will particularly enjoy the novelty; and methods of modifying existing paper-roll core manufacturing equipment to manufacture soluble cleanser-dispensing paper-roll cores.

### CROSS-REFERENCE TO RELATED APPLICATIONS

This application is a continuation-in-part of application Ser. No. 10/948,602, filed Sep. 23, 2004 and claims the benefit of provisional application Ser. No. 60/715,833, filed Sep. 9, 2005, and provisional application Ser. No. 60/750,904, filed Dec. 16, 2005, both of which are hereby incorporated by reference.

### FIELD OF THE INVENTION

This invention relates to dispensing paper-roll core systems. More particularly, it relates to paper-roll cores that are water-soluble and release cleansers into water.

### BACKGROUND OF THE INVENTION

Typical paper-roll cores, such as toilet paper-roll cores, paper towel roll cores, etc., are not flushable. Typical paper-roll cores have no further use after the paper has been removed from them so they are thrown away, generating landfill waste.

Typically, toilet bowls (and garbage disposals, to a lesser extent) require frequent cleaning to maintain a sanitary condition. Unfortunately, toilets are not sanitized as often as may be preferable, because the required cleansers are not readily at hand at frequent intervals. Additionally, no system exists for cleaning and/or sanitizing a toilet bowl with paper-roll cores.

Therefore, a need exists to provide for a convenient way to sanitize the toilet bowl at frequent intervals. Even further, a need exists to increase the usefulness of paper-roll cores. In particular, a need exists for a system for cleaning and/or sanitizing a toilet bowl with paper-roll cores.

### SUMMARY OF THE INVENTION

One embodiment of the present invention provides a core for use with a convolutely wound material. The core comprises a water-soluble support material and a cleanser disposed upon the water-soluble support material. The cleanser further comprises an acid and a base. The core is soluble upon contact with water and the cleanser is disposable within the water upon initiation of the solubilization of the core.

Another embodiment of the present invention provides a core for use with a convolutely wound material. The core comprises a water-soluble support material, a cleanser disposed upon the water-soluble support material, and a binder material. The cleanser further comprises an acid and a base. The binder material provides adhesion of at least one of the acid and the base of the cleanser to the water-soluble support material. The core is soluble upon contact with water and the cleanser is disposable within the water upon initiation of the solubilization of the core.

### BRIEF DESCRIPTION OF THE DRAWINGS

FIG. 1 shows a perspective view illustrating a dispensing paper-roll core system according to the present invention;

FIG. 2 shows a perspective view illustrating a layered dispensing core containing chemical layers;

FIG. 3 shows a cross-sectional view illustrating the paper-roll core according to FIG. 2;

FIG. 4 shows a perspective view illustrating a spiral dispensing core;

FIG. 5 shows a perspective view illustrating a paper extruded dispensing core having chemicals incorporated into the paper;

FIG. 6 shows a perspective view illustrating a plastic extruded dispensing core having chemicals incorporated into the plastic;

FIG. 7A shows a side plan view illustrating a dispensing core with instructional indicia;

FIG. 7B shows the dispensing core of FIG. 7A with an alternative preferred instructional indicia;

FIG. 8A shows a side plan view illustrating a dispensing core with entertaining indicia;

FIG. 8B shows the dispensing core of FIG. 8A illustrating a dispensing core with floating indicia;

FIG. 9 shows a side view, partially in section, illustrating a dispensing core being put into a toilet bowl;

FIG. 10A shows a side view, partially in section, illustrating the toilet bowl according to FIG. 9, after the dispensing core has dissolved and released chemicals into the water;

FIG. 10B shows a side view illustrating the use of the dispensing core for scrubbing;

FIG. 11 shows a side view, partially in section, illustrating a dispensing core being used in a garbage disposal;

FIG. 12 shows a perspective view illustrating a batch vat having chemicals added to it;

FIG. 13 shows a flow diagram illustrating a method according to the present invention;

FIG. 14 shows a flow diagram illustrating a method according to the present invention;

FIG. 15 shows a flow diagram illustrating a method according to the present invention;

FIG. 16 shows a flow diagram illustrating a method according to the present invention;

FIG. 17 shows a diagram illustrating a winder;

FIG. 18 shows a diagram illustrating a winder;

FIG. 19 shows a diagram illustrating a winder;

FIG. 20 shows a diagram illustrating a winder;

FIG. 21 shows a perspective view illustrating a compressed powder dispensing core having chemicals compressed into a solid tube shape;

FIG. 22A shows a flow diagram illustrating a method according to the present invention;

FIG. 22B shows a flow diagram illustrating a method according to the present invention;

FIG. 23A shows a diagram illustrating a winder;

FIG. 23B shows a flow diagram illustrating a method according to the present invention;

FIG. 24 shows a perspective view illustrating a dispensing core having a removable cover;

FIG. 25 shows a perspective view illustrating a dispensing core having at least one patch of cleaning chemicals; and,

FIG. 26 shows a perspective view illustrating a dispensing core.

### DETAILED DESCRIPTION OF THE INVENTION

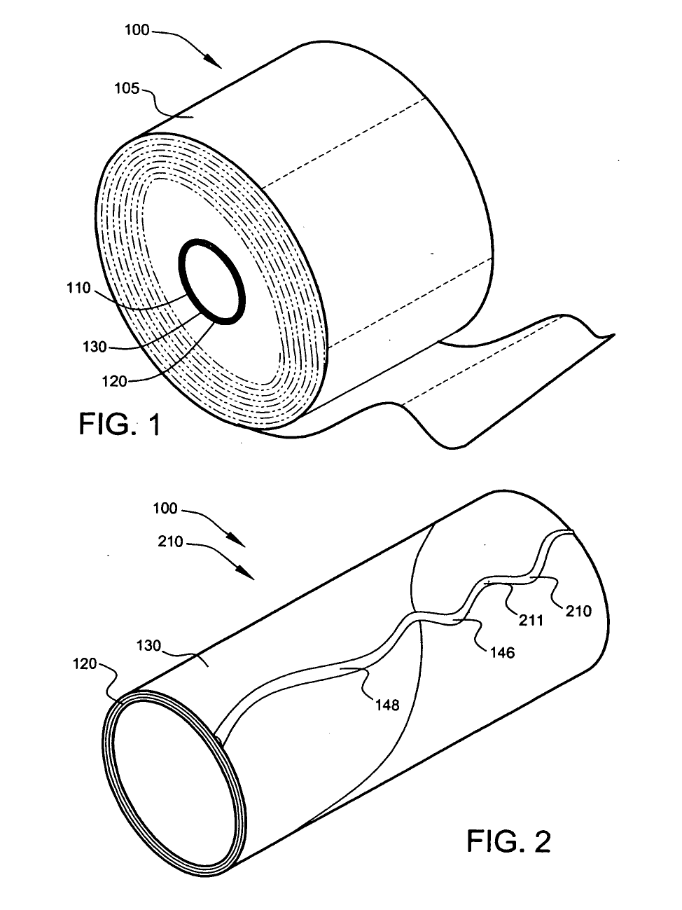

FIG. 1 shows a perspective view illustrating dispensing paper-roll core system 100 according to a preferred embodiment of the present invention. Preferably, dispensing paper-roll core system 100 comprises paper roll 105 convolutely disposed about dispensing core 110, as shown. Preferably, paper roll 105 comprises a roll of disposable paper products, such as, for example, toilet tissue, paper towels, shop towels, etc. Most preferably, paper roll 105 comprises toilet tissue, as shown. Preferably, dispensing core 110 comprises a hollow, preferably circular, support core around which paper roll 105 is wound, as shown. Preferably, dispensing core 110 (at least embodying herein wherein such soluble paper-roll core means comprises such cleanser means) is water-soluble and contains cleaning ingredients 120 that are released into water 951 when dispensing core 110 dissolves, as shown. Upon reading the teachings of this specification, those of ordinary skill in the art will now understand that, under appropriate circumstances, such as user preference, advances in technology, intended use, types of paper, etc., other dispensing core features, such as different shapes, additional ingredients, other types of rolls of material, cores having multiple separable parts, etc., may suffice.

Preferably, dispensing core 110 comprises rapidly-dissolving water-soluble support material 130, as shown, such as, for example, Dissolvo™ paper (manufactured by Gilbreth Packaging Systems of Croydon, Pa., USA), polyvinyl alcohol polymers, water-soluble plastics, hydrolysable plastics, starch, gelatin, etc. Upon reading the teachings of this specification, those of ordinary skill in the art will now understand that, under appropriate circumstances, such as user preference, advances in technology, intended use, etc., other water-soluble materials, such as ion-sensitive soluble plastics, starch-based plastics, composite materials, etc., may suffice.

Preferably, after paper roll 105 (at least embodying herein at least one paper roll adapted to provide at least one such roll of paper) has been used up, dispensing core 110 may be placed in wet plumbing fixture 101, as shown, to clean and disinfect plumbing fixture 101. Preferably, where paper roll 105 (at least embodying herein wherein such at least one paper-roll comprises at least one toilet paper-roll) comprises toilet tissue, dispensing core 110 (at least embodying herein soluble paper-roll core means for solubly coring at least one such roll of paper) is disposed of by placing it in toilet bowl 950 containing water 951, where it rapidly dissolves, releasing cleaning ingredients 120 (at least embodying herein cleanser means for cleaning at least one plumbing fixture), as shown, which then clean and disinfect at least the water-contacting surfaces of toilet bowl 950. In a further preferred embodiment, where paper roll 105 (at least embodying herein wherein such at least one paper-roll comprises at least one paper towel roll) comprises paper towels, dispensing core 110 (at least embodying herein at least one soluble paper-roll core adapted to solubly core at least one paper-roll) is disposed of by washing it down garbage disposal 1100 or a sink, as shown, in which case it rapidly dissolves, releasing cleaning ingredients 120 (at least embodying herein at least one cleanser adapted to clean at least one plumbing fixture) into garbage disposal 1100 and/or into the sink pipes. Upon reading the teachings of this specification, those of ordinary skill in the art will now understand that, under appropriate circumstances, such as user preference, advances in technology, intended use, etc., other plumbing fixtures, such as drains, dishwashers, washing machines, etc., may suffice.

Typically, the tail end of paper roll 105 (at least embodying herein paper roll means for providing at least one such roll of paper) is connected to dispensing core 110, preferably with glue 211 (at least embodying herein connector means for connecting such paper roll means about such soluble paper-roll core means, and at least embodying herein at least one connector adapted to connect such at least one paper roll about such at least one soluble paper-roll core, and at least embodying herein wherein said at least one connector is water-soluble), which is preferably water-soluble adhesive. Preferably, glue 211 is a water, glycerin, and/or alcohol-based adhesive. Preferably, glue 211 comprises colorant 148 and/or cleaning ingredients 120 (particularly disinfectant 146) for release into water, as shown and further described in FIG. 2. Upon reading the teachings of this specification, those with ordinary skill in the art will now understand that, under appropriate circumstances, considering such issues as advances in technology, user preference, chemical compatibility, etc., other connectors, such as embossing the end of the paper onto the core, other connector ingredients, flushable non-soluble connectors, etc., may suffice.

FIG. 2 is a perspective view illustrating layered dispensing core 210 containing layers of cleaning ingredients 120 according to a preferred embodiment of the present invention. Preferably, dispensing core 110 comprises layered dispensing core 210, as shown. Preferably, cleaning ingredients 120 (at least embodying herein wherein such at least one soluble paper-roll core comprises such at least one cleanser) and water-soluble material 130 (at least embodying herein wherein such at least one layer comprises a plurality of layers adapted to provide a plurality of layers each of at least one water-soluble material) are layered together, as shown, preferably during a spiral-winding manufacturing process, to make layered dispensing core 210 (at least embodying herein wherein such soluble paper-roll core means comprises layer means for providing layering of such soluble paper-roll core means). Upon reading the teachings of this specification, those of ordinary skill in the art will now understand that, under appropriate circumstances, such as user preference, advances in technology, intended use, etc., other manufacturing processes, such as surface coating the finished tube, etc., may suffice.

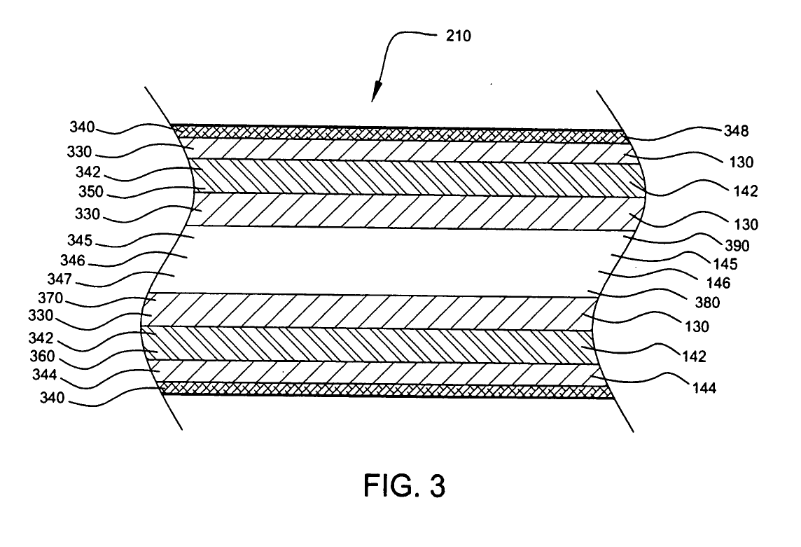

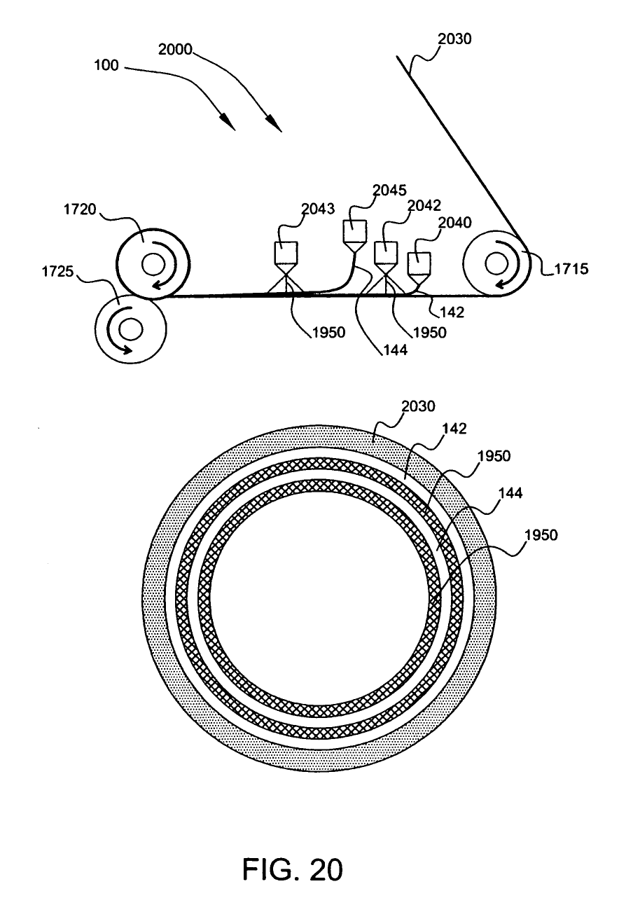

FIG. 3 is a cross-sectional view illustrating dispensing core 210 according to FIG. 2. Preferably, cleaning ingredients 120 at least comprise at least one of acid 142, base 144, cleanser 145, and/or disinfectant 146, as shown. Preferably, cleaning ingredients 120 that are reasonably safe and non-toxic to humans are used. Preferably, layered dispensing core 210 (at least embodying herein wherein such at least one soluble paper-roll core comprises at least one layer adapted to provide at least one layering of such at least one soluble paper-roll core) comprises water-soluble material layer 330, coating 340, acid layer 342 (at least embodying herein wherein such at least one layer comprises at least one acid layer adapted to provide at least one acid material layer) having acid 142, base layer 344 (at least embodying herein wherein such at least one layer comprises at least one basic layer adapted to provide at least one basic material layer) having base 144, cleanser layer 345 (at least embodying herein wherein such at least one layer comprises at least one cleanser layer adapted to provide at least one cleanser material layer) having cleanser 145, and disinfectant layer 346 (at least embodying herein wherein such at least one layer comprises at least one disinfectant layer adapted to provide at least one disinfectant material layer) having disinfectant 146, as shown. Preferably, incompatible chemicals (such as those providing gas release, for stirring and/or entertainment purposes, when mixed) are separated from each other by impermeable layers (such as, for example, sealant 1950, as shown especially in FIG. 20) or by encapsulation. Preferably, compatible chemicals are placed together in a single layer, as shown. Upon reading the teachings of this specification, those of ordinary skill in the art will now understand that, under appropriate circumstances, such as user preference, advances in technology, intended use, etc., other ingredients, such as preservatives, enzymes, fewer layers, more layers, fewer ingredients, more ingredients, multiple cleaning ingredients in one layer, etc., may suffice.

Preferably, acid 142 (at least embodying herein wherein such at least one gas-releaser comprises at least one acid) comprises at least one organic and/or at least one inorganic acid, preferably citric acid, boric acid, hydrochloric acid, hydroxyacetic acid, and/or acetic acid, etc. Upon reading the teachings of this specification, those of ordinary skill in the art will now understand that, under appropriate circumstances, such as user preference, advances in technology, intended use, etc., other acids, such as fumaric acid, sulfuric acid, hydrogen peroxide, other acids, etc., may suffice.

Preferably, base 144 (at least embodying herein wherein such at least one gas-releaser comprises at least one alkali carbonate) comprises at least one base that releases gas when reacted with acid 142, preferably at least one carbonate, preferably calcium carbonate, sodium carbonate, and/or potassium carbonate, etc. Upon reading the teachings of this specification, those of ordinary skill in the art will now understand that, under appropriate circumstances, such as user preference, advances in technology, intended use, etc., other bases, such as, potassium hydroxide, sodium hydroxide, ammonia, etc., may suffice.

Preferably, cleanser 145 (at least embodying herein wherein such at least one cleanser comprises at least one detergent adapted to dissolve organic debris, and at least embodying herein wherein such at least one cleanser comprises at least one surfactant adapted to dislodge organic debris from such at least one plumbing fixture) comprises at least one of at least one surfactant, at least one soap, and/or at least one detergent, preferably at least one of sodium laureth sulfate, sodium lauryl sulfate, tetrasodium pyrophosphate, anionic surfactants, wetting agents, sodium borate, and/or tetrasodium EDTA, etc. Upon reading the teachings of this specification, those of ordinary skill in the art will now understand that, under appropriate circumstances, such as user preference, advances in technology, intended use, etc., other surfactants, soaps, and/or detergents, such as alkyl glucosides, ammonium lauryl sulfate, sodium stearate, dialkylmethylamines, etc., may suffice.

Preferably, disinfectant 146 disinfects water 951 and wet plumbing fixture 101 surfaces by killing microbes, more preferably by killing bacteria, molds, and/or viruses. Preferably, disinfectant 146 (at least embodying herein at least one disinfectant adapted to disinfect such at least one plumbing fixture) comprises at least one disinfectant, preferably at least one of pine oil, isopropyl alcohol, Octyl decyl dimethyl ammonium chloride, Dioctyl dimethyl ammonium chloride, Didecyl dimethyl ammonium chloride, Alkyl dimethyl benzyl ammonium chlorides, 2-butoxyethanol, bleach, thymol, eucalyptol, and/or menthol, etc. Upon reading the teachings of this specification, those of ordinary skill in the art will now understand that, under appropriate circumstances, such as user preference, advances in technology, intended use, etc., other disinfectants, such as other alcohols, oxidizers, iodine compounds, silver compounds, phenolic compounds, quaternary ammonium compounds, etc., may suffice.

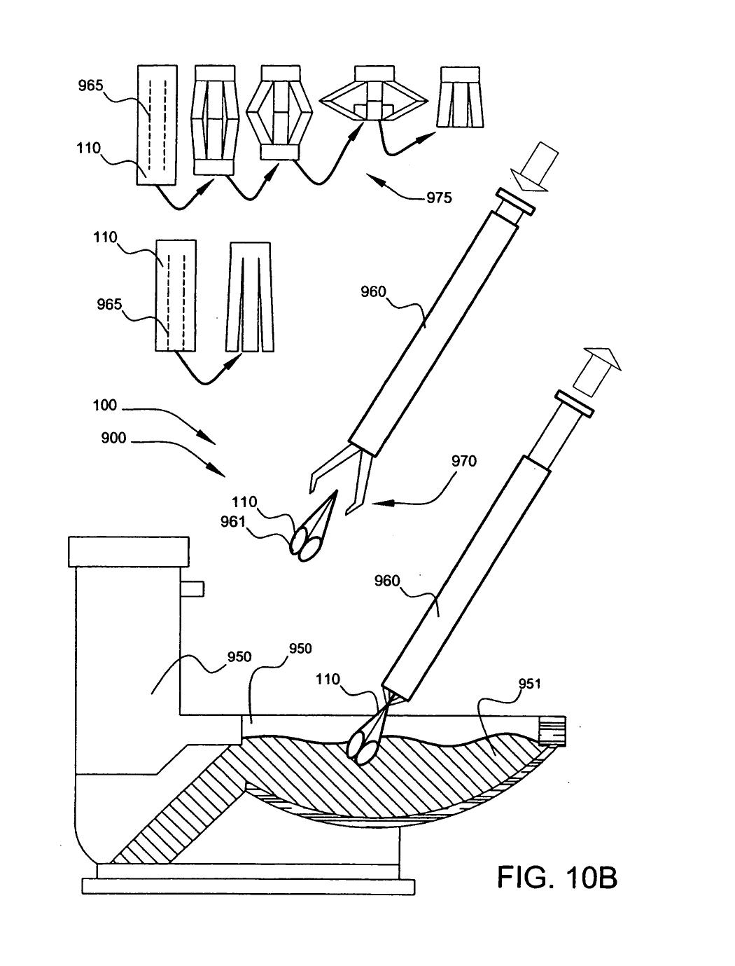

Most preferably, acid 142 comprises citric acid. Most preferably, base 144 comprises sodium bicarbonate. Preferably, when layered dispensing core 210 (at least embodying herein at least one gas-releaser adapted to release gas into at least one quantity of water contained in such at least one plumbing fixture) is dissolved in water 951, acid 142 reacts in solution with base 144 to generate carbon dioxide gas 143, as shown especially in FIG. 10, which preferably releases gas bubbles and agitates water 951 to help distribute cleaning ingredients 120, as shown. Also, the bubbling action of released carbon dioxide gas 143 provides a useful and entertaining visual indicator to the user that layered dispensing core 210 is working properly. In yet another preferred embodiment, carbon dioxide gas is stored dissolved in the dispensing core 210 material (at least embodying herein wherein such at least one gas-releaser comprises at least one gas). Upon reading the teachings of this specification, those of ordinary skill in the art will now understand that, under appropriate circumstances, such as user preference, advances in technology, intended use, etc., other gas-releasing reactions, such as other acid/carbonate reactions, reactions releasing other gasses, etc., may suffice.

Preferably, cleaning ingredients 120 further comprise at least one bleaching agent 347, as shown. Preferably, bleaching agent 347 bleaches away stains in plumbing fixture 101. Preferably, bleaching agent 347 (at least embodying herein wherein said at least one soluble paper-roll core comprises at least one bleaching agent) comprises at least one chlorine-releasing chemical, at least one bromine-releasing chemical, and/or at least one oxygen-releasing chemical. Preferably, bleaching agent 347 comprises at least one of cyanuric acid, trichloroisocyanuric acid, sodium percarbonate, sodium dichloroisocyanurate, 1-Bromo-3-Chloro-5, 5-Dimethylhydantoin, peroxide, and/or sodium hypochlorite, etc. Upon reading the teachings of this specification, those with ordinary skill in the art will now understand that, under appropriate circumstances, considering such issues as advances in technology, user preference, chemical compatibility requirements, etc., other bleaching agents, such as reducing bleaches, other oxidizing bleaches, etc., may suffice.

Preferably, at least one of water-soluble material layer 330, coating 340, acid layer 342, base layer 344, cleanser layer 345, and disinfectant layer 346 comprise soluble colorant 348 (at least embodying herein wherein such at least one layer comprises at least one color layer adapted to provide at least one color material layer), as shown. Preferably, sealant 1950 layer may be used to separate other layers from each other, as shown especially in FIG. 20. Preferably, soluble colorant 348 (at least embodying herein at least one color adapted to color at least one quantity of water contained in such at least one plumbing fixture) is released into water 951 in plumbing fixture 101 when layered dispensing core 210 dissolves, preferably coloring (preferably blue, since there may be a pre-existing association in user's minds between blue color and cleansers) water 951 in plumbing fixture 101 and providing a useful and entertaining indicator to the user that layered dispensing core 210 is working properly. Upon reading the teachings of this specification, those of ordinary skill in the art will now understand that, under appropriate circumstances, such as user preference, advances in technology, intended use, chemical requirements, etc., other arrangements, such as a separate color layer, multiple colors, etc., may suffice.

Preferably, soluble colorant 348 changes color while in plumbing fixture 101. Preferably, soluble colorant 348 changes color in response to chemical effects of cleaning ingredients 120 being dissolved and/or being consumed by cleansing. Preferably, soluble colorant 348 changes color in response to changes in the pH of water 951 in plumbing fixture 101 as cleaning ingredients 120 dissolve into water 951 and are then consumed. Preferably, soluble colorant 348 changes color in response to temperature changes in water 951 caused by the reactions (generally exothermic) of cleaning ingredients 120 with water 951 and each other (thermochromic color). Upon reading the teachings of this specification, those with ordinary skill in the art will now understand that, under appropriate circumstances, considering such issues as advances in technology, user preference, etc., other color-changing colorants, such as timed-release colors, oxidizing colors, photochromic colors, hydrochromic colors, non-visible spectrum colors, etc., may suffice.

Preferably, coating 340 is optional. Preferably, coating 340 (at least embodying herein wherein such at least one layer comprises at least one coating layer adapted to provide at least one coating material layer) comprises at least one of at least one desiccant, at least one printing layer, sealant 1950, at least one print sealer, and/or at least one other material that modifies the inner and/or outer surface of layered dispensing core 210. Upon reading the teachings of this specification, those of ordinary skill in the art will now understand that, under appropriate circumstances, such as user preference, advances in technology, intended use, etc., other coatings, such as no coating, a waterproof coating, decorative coatings, etc., may suffice.

Preferably, dispensing core 110 comprises fragrance 350, as shown. Preferably, fragrance 350 provides at least one scent that is pleasant to the user (floral, fresh air, cinnamon, etc.) and/or at least one scent that indicates the presence of cleansers (pine scent, bleach scent, etc.). Preferably, fragrance 350 is detectable by the user prior to dissolving dispensing core 110. More preferably, fragrance 350 is detectable by the user after dissolving dispensing core 110 but before flushing. Preferably, fragrance 350 (at least embodying herein at least one fragrance) has a lingering scent detectable by the user after dissolving dispensing core 110 and after flushing. Upon reading the teachings of this specification, those with ordinary skill in the art will now understand that, under appropriate circumstances, considering such issues as advances in technology, user preference, etc., other arrangements, such as multiple scents, odor-neutralizing, humorous disgusting scents, etc., may suffice.

Preferably, dispensing core 110 comprises at least one water softener 360, as shown. Preferably, water softeners 360 sequester calcium and/or magnesium ions in water 951 to prevent the calcium and magnesium ions from interfering with the action of cleanser chemicals 120. Preferably, water softener 360 comprises at least one phosphate. Preferably, water softener 360 (at least embodying herein wherein said at least one soluble paper-roll core further comprises at least one water softener chemical) comprises at least one ionic sodium compound, preferably at least one of sodium chloride, sodium zeolite, sodium sesquicarbonate, sodium triployphosphate, sodium bisulfate, and/or sodium carbonate, etc. Upon reading the teachings of this specification, those with ordinary skill in the art will now understand that, under appropriate circumstances, considering such issues as advances in technology, user preference, etc., other water softeners, such as potassium salts, etc., may suffice.

Preferably, dispensing core 110 comprises at least one encapsulant 370, as shown. Preferably, encapsulant 370 encapsulates at least one cleaning ingredient 120 to prevent incompatible cleaning ingredients 120 from contacting each other prior to dissolving dispensing core 110, or to prevent encapsulated cleaning ingredients 120 from being in contact with the air, or to temporarily prevent encapsulated cleaning ingredients 120 from being in contact with water 951. Preferably, encapsulant 370 is water-soluble and/or water-permeable. Preferably, encapsulant 370 (at least embodying herein wherein said at least one soluble paper-roll core further comprises at least one encapsulant adapted to encapsulate said at least one cleanser) comprises at least one of ethyl cellulose, polyvinyl alcohol, sugar, starch, and/or sol-gel (cross-linked silicon material) (at least embodying herein wherein said at least one bulk unitary material comprises sol-gel; and at least embodying herein wherein said at least one layer comprises sol-gel). Upon reading the teachings of this specification, those with ordinary skill in the art will now understand that, under appropriate circumstances, considering such issues as advances in technology, user preference, chemical compatibility requirements, etc., other encapsulants, such as other water-soluble polymers, sugars, gum acacia, modified food starch, etc., may suffice.

Preferably, dispensing core 110 comprises at least one desiccant 380, as shown. Preferably, desiccant 380 absorbs atmospheric water vapor in order to keep dispensing core 110 dry prior to use. Preferably, desiccant 380 (at least embodying herein wherein said at least one soluble paper-roll core further comprises at least one desiccant) comprises anhydrous silica gel. Upon reading the teachings of this specification, those with ordinary skill in the art will now understand that, under appropriate circumstances, considering such issues as advances in technology, user preference, chemical compatibility requirements, etc., other desiccants, such as clay, calcium oxide, calcium sulfate, etc., may suffice.

Preferably, dispensing core 110 comprises at least one deodorant 390, as shown. Preferably, deodorant 390 functions to absorb and/or neutralize odors occurring in plumbing fixture 101. Preferably, deodorant 390 (at least embodying herein wherein said at least one soluble paper-roll core comprises at least one deodorant) comprises at least one of sodium bicarbonate, charcoal, zeolite, sodium zeolite, and/or potassium zeolite, etc. Upon reading the teachings of this specification, those with ordinary skill in the art will now understand that, under appropriate circumstances, considering such issues as advances in technology, user preference, etc., other deodorants, such as para-dichlorobenzene, enzymes, oxidizers, other absorbers, etc., may suffice.

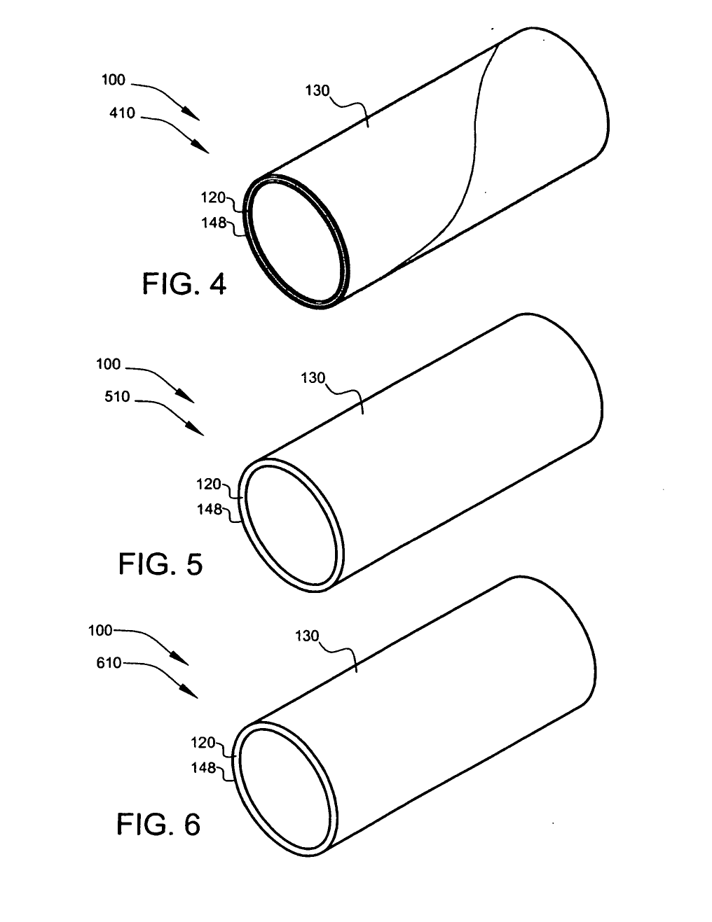

FIG. 4 is a perspective view illustrating spiral dispensing core 410 according to a preferred embodiment of the present invention. Preferably, dispensing core 110 comprises spiral dispensing core 410, as shown. Preferably, cleaning ingredients 120 and colorant 148 are incorporated into water-soluble material 130, as shown, which is then spiral wound around a mandrel to form spiral dispensing core 410. Preferably, cleaning ingredients 120 and colorant 148 are released into water 951 when spiral dispensing roll core 410 is placed in wet plumbing fixture 101 and dissolves, as shown. Upon reading the teachings of this specification, those of ordinary skill in the art will now understand that, under appropriate circumstances, such as user preference, advances in technology, intended use, etc., other arrangements, such as cleaning ingredients incorporated into the water-soluble material and also applied in layers, etc., may suffice.

FIG. 5 is a perspective view illustrating paper extruded dispensing core 510 having cleaning ingredients 120 incorporated into water-soluble material 130 according to a preferred embodiment of the present invention. Preferably, dispensing core 110 comprises paper extruded dispensing core 510, as shown. Preferably, cleaning ingredients 120 and colorant 148 are incorporated into water-soluble material 130, as shown, which preferably comprises water-soluble paper pulp, which is then extruded and dried to form paper extruded dispensing core 510 (at least embodying herein wherein such soluble paper-roll core means comprises unitary bulk means for providing bulk unitary material for such soluble paper-roll core means, and at least embodying herein wherein such at least one soluble paper-roll core comprises at least one unitary bulk adapted to provide at least one bulk unitary material for such at least one soluble paper-roll core). Preferably, cleaning ingredients 120 and colorant 148 are released into water 951 when paper extruded dispensing core 510 is placed in wet plumbing fixture 101 and dissolves, as shown in FIG. 10. Upon reading the teachings of this specification, those of ordinary skill in the art will now understand that, under appropriate circumstances, such as user preference, advances in technology, intended use, etc., other arrangements, such as cleaning ingredients incorporated into the water-soluble material and also applied in layers, etc., may suffice.

FIG. 6 is a perspective view illustrating plastic extruded dispensing core 610 having cleaning ingredients 120 incorporated into the plastic water-soluble material 130 according to a preferred embodiment of the present invention. Preferably, dispensing core 110 comprises plastic (and/or polymer) extruded dispensing core 610, as shown. Preferably, cleaning ingredients 120 and colorant 148 are incorporated into water-soluble material 130, as shown, which preferably comprises at least one liquid water-soluble polymer, which is then extruded and cured to form plastic extruded dispensing core 610 (at least embodying herein wherein such soluble paper-roll core means comprises plastic means for providing plastic material for such soluble paper-roll core means, and at least embodying herein wherein such at least one soluble paper-roll core comprises at least one plastic adapted to provide at least one plastic material for such at least one soluble paper-roll core), as shown. Preferably, cleaning ingredients 120 and colorant 148 are released into water 951 when plastic extruded dispensing core 610 is placed in wet plumbing fixture 101 and dissolves, as shown in FIG. 10. Upon reading the teachings of this specification, those of ordinary skill in the art will now understand that, under appropriate circumstances, such as user preference, advances in technology, intended use, etc., other arrangements, such as cleaning ingredients incorporated into the water-soluble material and also applied in layers, etc., may suffice.

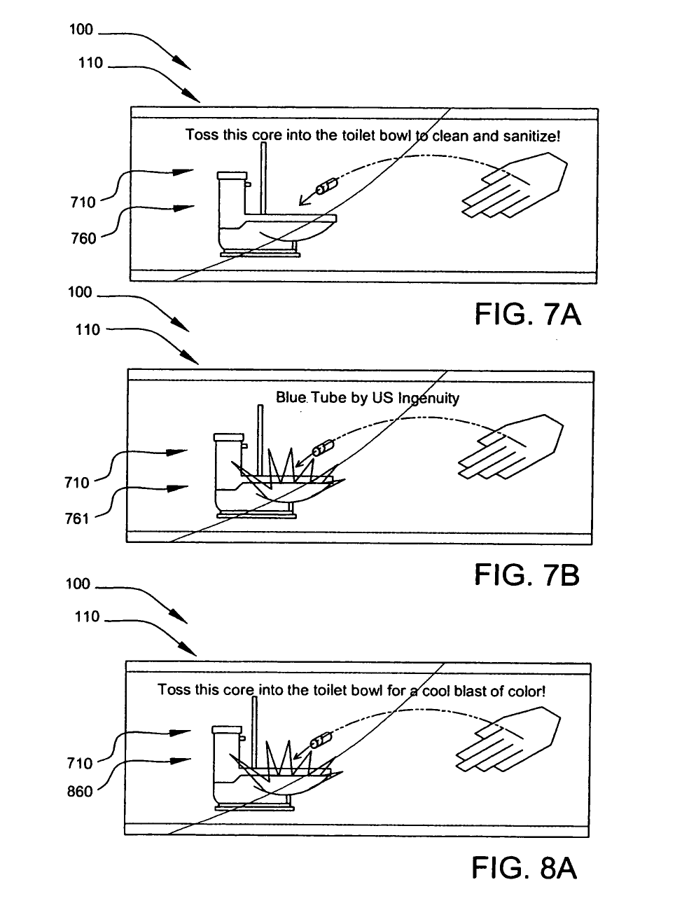

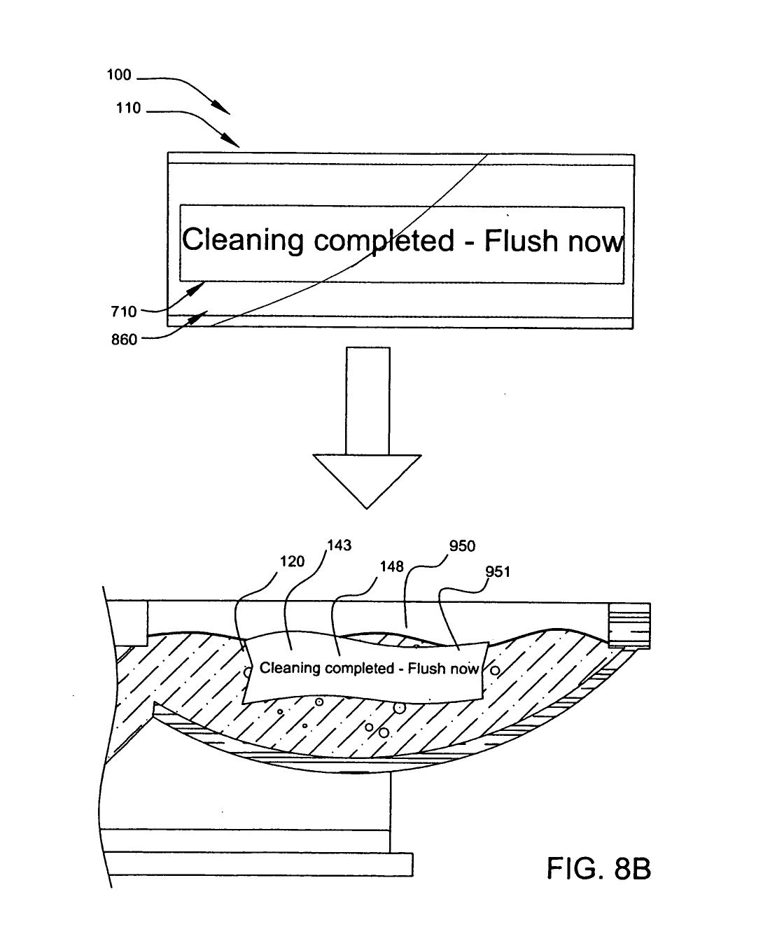

FIG. 7A is a side plan view illustrating dispensing core 110 with instructional indicia 760 according to a preferred embodiment of the present invention. Preferably, dispensing core 110 comprises indicia 710, as shown. Preferably, indicia 710 comprises instructional indicia 760, as shown. Preferably, instructional indicia 760 instructs users in how to use dispensing core 110 for cleaning and sanitizing purposes, as shown. Preferably, instructional indicia 760 (at least embodying herein at least one instructional indicia adapted to visually instruct at least one user) are visible when paper roll 105 is removed from dispensing core 110, as shown. Example indicia, as shown in FIG. 7A and FIG. 8A, might include pictures and words as illustrated in FIG. 7A and FIG. 8A, e.g., “Toss this core into the toilet bowl to clean and sanitize!”; “Toss this core into the toilet bowl for a cool blast of color!” Upon reading the teachings of this specification, those of ordinary skill in the art will now understand that, under appropriate circumstances, such as user preference, advances in technology, intended use, etc., other indicia, such as other instructions, other graphics, etc., may suffice.

FIG. 7B shows dispensing core 110 of FIG. 7A with another preferred instructional indicia 760 comprising advertising indicia 761. Preferred advertising indicia 761 include pictures and words as illustrated in FIG. 7B indicating the brand and manufacturer of dispensing core 110. Preferably, advertising indicia 761 (at least embodying herein wherein said at least one indicia comprises at least one advertising indicia adapted to provide advertising information to at least one user) comprise company names, advertising slogans, web addresses for coupons or other offers, peel-of coupons, etc. Upon reading the teachings of this specification, those with ordinary skill in the art will now understand that, under appropriate circumstances, considering such issues as advances in technology, user preference, etc., other advertising indicia may suffice.

FIG. 8A is a side plan view illustrating dispensing core 110 with entertaining indicia 860 according to a preferred embodiment of the present invention. Preferably, entertaining indicia 860 instructs users, particularly children, in how to use dispensing core 110 for entertainment purposes, as shown, (although the cleaning and sanitizing functions are preferably still present and are still performed). Preferably, entertaining indicia 860 (at least embodying herein at least one entertainment indicia adapted to visually entertain at least one user) is visible when paper roll 105 is removed from dispensing core 110, as shown. Upon reading the teachings of this specification, those of ordinary skill in the art will now understand that, under appropriate circumstances, such as user preference, advances in technology, intended use, etc., other indicia, such as other instructions, other graphics, comics, characters, etc., may suffice.

FIG. 8B shows dispensing core 110 of FIG. 8A illustrating dispensing core 110 with floating indicia 870. Preferably, indicia 710 comprises floating indicia 870, as shown. Preferably, floating indicia 870 is printed on at least one material that is either insoluble (but flushable) or less soluble than dispensing core 110. Preferably, floating indicia 870 is hidden within (or on the inside surface of) dispensing core 110, as shown, and becomes visible to the user after dispensing core 110 has dissolved, as shown. Preferably, floating indicia 870 is flushed away after use. Preferably, floating indicia 870 (at least embodying herein wherein said at least one indicia is adapted to be visible after said at least one soluble paper-roll core has dissolved) comprises instructions, jokes, fortunes, advertising, etc. Upon reading the teachings of this specification, those with ordinary skill in the art will now understand that, under appropriate circumstances, considering such issues as advances in technology, user preference, etc., other arrangements, such as multiple floating indicia, novelty shapes, other flushable decorations such as glitter, confetti, fizzing materials, target indicia, etc., may suffice.

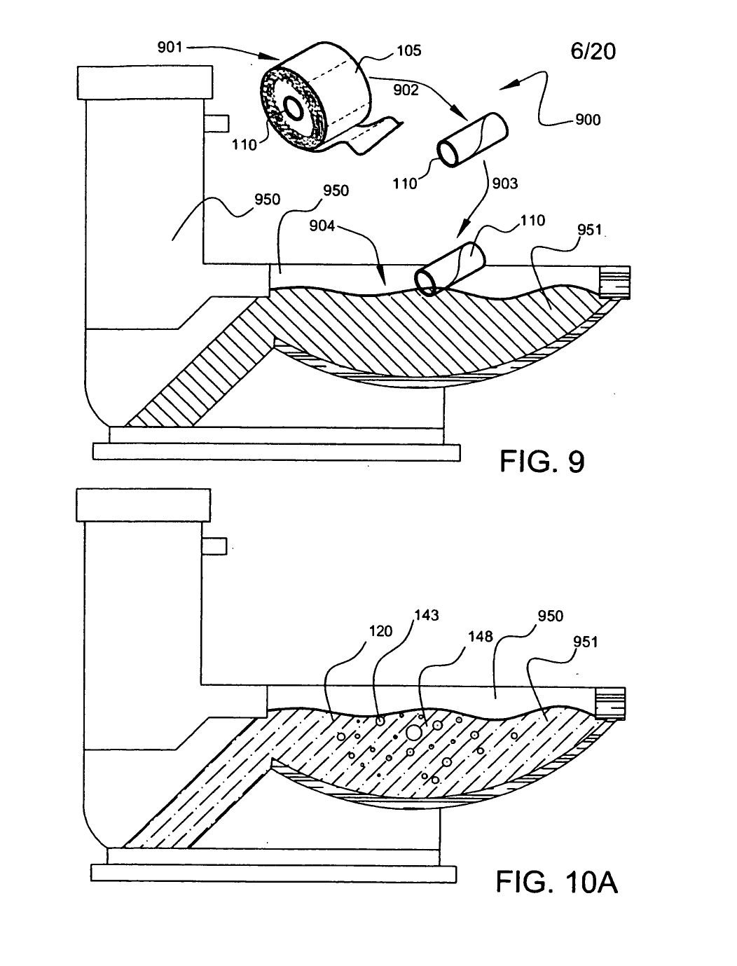

FIG. 9 is a side view, partially in section, illustrating dispensing core 110 being put into toilet bowl 950 (at least embodying herein wherein such at least one plumbing fixture comprises at least one toilet bowl) according to a preferred embodiment of the present invention. Preferably, dispensing paper-roll core system 100 comprises method 900 comprising the steps of: acquiring 901 paper roll 105 having dispensing core 110 (at least embodying herein acquiring at least one paper-roll having at least one cleanser-releasing soluble core); removing 902 substantially all paper from paper roll 105 (at least embodying herein removing substantially all paper from such at least one paper-roll); placing 903 dispensing core 110 in plumbing fixture 101 (at least embodying herein placing such at least one cleanser-releasing soluble core in at least one plumbing fixture); and wetting 904 dispensing core 110 (at least embodying herein wetting such at least one cleanser-releasing soluble core), as shown. FIG. 9 shows dispensing core 110 at approximately the moment it hits water 951. Upon reading the teachings of this specification, those of ordinary skill in the art will now understand that, under appropriate circumstances, such as user preference, advances in technology, intended use, etc., other steps, such as reading instructional indicia, waiting a certain amount of time before flushing, removing less than all of the paper from the dispensing core, etc., may suffice.

FIG. 10A shows a side view, partially in section, illustrating toilet bowl 950 according to FIG. 9, after dispensing core 110 has dissolved and released cleaning ingredients 120 and colorant 148 into water 951. Preferably, dispensing core 110 dissolves and releases cleaning ingredients 120 and colorant 148 into water 951, as shown, preferably within one minute of wetting, more preferably within thirty seconds of wetting, most preferably within ten seconds of wetting. Preferably, the user does not rinse away or flush water 951 for a period of time sufficient to permit cleaning chemicals 120 to clean and sanitize at least one portion of toilet bowl 950, preferably at least about five minutes, more preferably at least about three minutes, most preferably at least about one minute. Upon reading the teachings of this specification, those of ordinary skill in the art will now understand that, under appropriate circumstances, such as user preference, advances in technology, intended use, etc., other steps, such as flushing prior to using the dispensing roll, using a scrub brush on the toilet bowl, waiting overnight, waiting for a color change, flushing as soon as the core has dissolved, etc., may suffice.

FIG. 10B shows a side view illustrating the use of dispensing core 110 for scrubbing. Preferably, dispensing paper-roll core system 100 comprises handle 960, as shown. Preferably, handle 960 removably attaches to dispensing core 110, as shown, allowing dispensing core 110 to be rubbed against the side of toilet bowl 950 to physically scrub toilet bowl 950, as shown. Preferably, dispensing core 110 is compressed and folded prior to being attached to handle 960, as shown. In an alternate preferred embodiment, dispensing core 110 is torn along perforations 965 (at least embodying herein wherein said at least one soluble paper-roll core comprises at least one perforation adapted to assist tearing said at least one soluble paper-roll core) and/or folded to convert dispensing core 110 into a brush-like shape, as shown. Preferably, dispensing core 110 is adapted to dissolve at an appropriate rate for this use. Preferably, dispensing core 110 comprises flushable scrubbing-materials 961, preferably fibers and/or grits, to assist scrubbing. Preferably, method 900 further comprises the step of attaching 970 (at least embodying herein the step of attaching at least one handle to such at least one paper-roll) handle 960 to dispensing core 110. Preferably, method 900 further comprises the step of tearing 975 (at least embodying herein the step of tearing such at least one paper roll) dispensing core 110 to preferably form a brush-shape (two different embodiments of brush-shapes are shown). Preferably, the remnants of dispensing core 110 are released from handle 960 (at least embodying herein at least one handle adapted to assist handling of said at least one soluble paper-roll core) and are flushed after use. Upon reading the teachings of this specification, those with ordinary skill in the art will now understand that, under appropriate circumstances, considering such issues as advances in technology, user preference, etc., other arrangements, such as other types of handles, kits, other scrubbing-materials, other patterns of perforations, etc., may suffice.

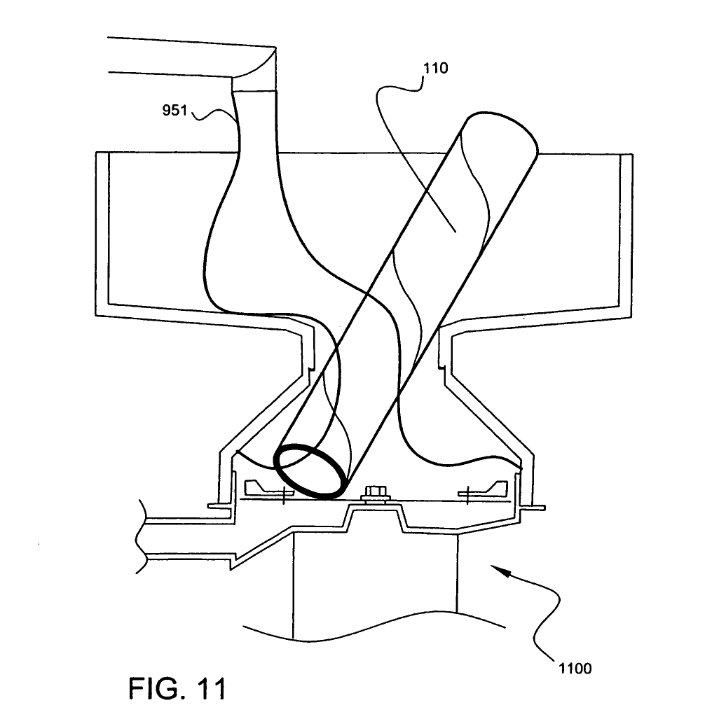

FIG. 11 is a side view, partially in section, illustrating dispensing core 110 being used in garbage disposal 1100 (at least embodying herein wherein such at least one plumbing fixture 101 comprises at least one garbage disposal) according to a preferred embodiment of the present invention. Preferably, dispensing core 110 may be wetted and dissolved before (as shown), during, and/or after activating garbage disposal 1100. Upon reading the teachings of this specification, those of ordinary skill in the art will now understand that, under appropriate circumstances, such as user preference, advances in technology, intended use, etc., other steps, such as adding abrasive material to the garbage disposal to assist cleansing action, etc., may suffice.

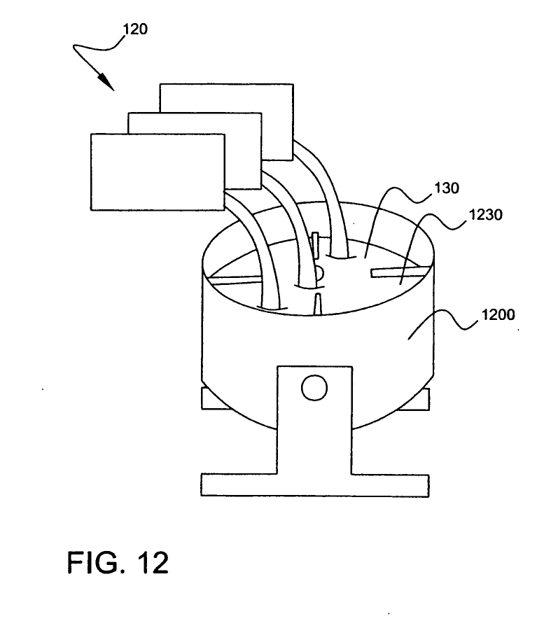

FIG. 12 is a perspective view illustrating batch vat 1200 having cleaning chemicals 120 added to it according to a preferred embodiment of the present invention. Preferably, for spiral dispensing core 410, paper extruded dispensing core 510, and plastic extruded dispensing core 610, cleaning chemicals 120 and colorant 148 are mixed into bulk support material 130 before support material 130 is shaped and/or formed, as shown.

Preferably, solvent 1230 is also added to bulk support material 130, as shown, to help liquefy bulk support material 130 for ease of processing. Preferably, solvent 1230 is a solvent for substantially all of the ingredients, and is substantially non-reactive with the ingredients. Preferably, after and/or as support material 130 is shaped and/or formed, solvent 1230 is substantially evaporated away. Preferably, solvent 1230 comprises alcohol (isopropyl alcohol, ethylated alcohol, ethanol, denatured alcohol, etc), ether, glycol, hydrocarbons, oil, etc. Upon reading the teachings of this specification, those with ordinary skill in the art will now understand that, under appropriate circumstances, considering such issues as advances in technology, user preference, chemical compatibility, etc., other solvents, such as water, organic solvents, ethylene glycol, ethers, etc., may suffice.

Preferably, chemicals 120 may be added in forms such as, for example, bulk chemicals, encapsulated chemicals, liquid, etc., as appropriate. For example, where citric acid and sodium bicarbonate are being added to a batch of support material 130 such as, for example, water-soluble paper pulp, sodium bicarbonate and citric acid may each be separately encapsulated in water-soluble polymer particles that only dissolve in low-ionic strength water, so that sodium bicarbonate and citric acid will not react with each other or the paper pulp during manufacturing, and will be released into the plumbing water to react with each other. Upon reading the teachings of this specification, those of ordinary skill in the art will now understand that, under appropriate circumstances, such as user preference, advances in technology, intended use, etc., other processes, such as suffusing the support material with chemicals after shaping, etc., may suffice.

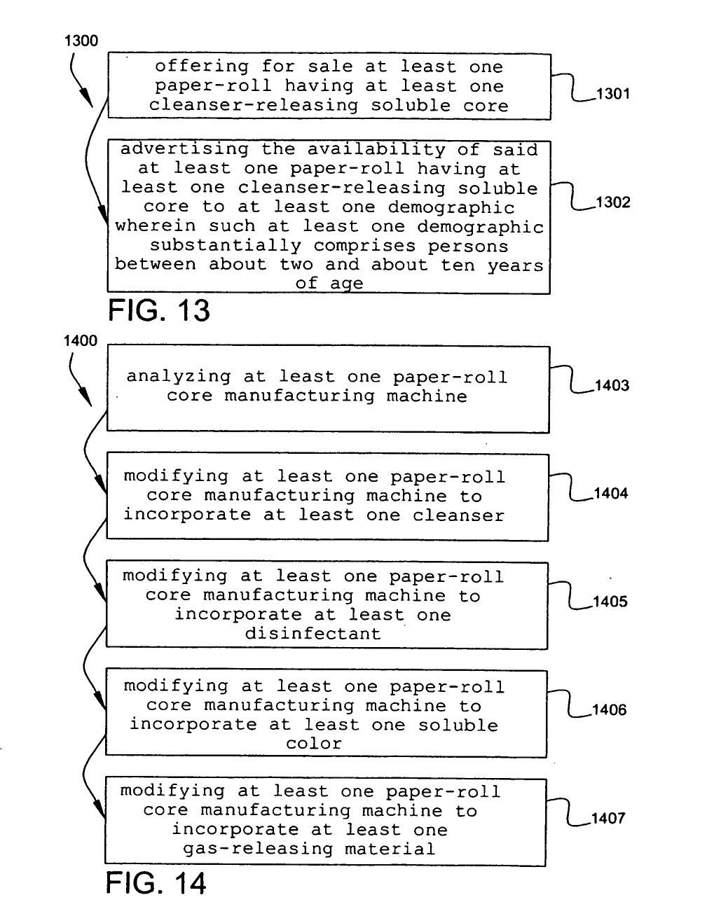

FIG. 13 shows a flow diagram illustrating method 1300 according to a preferred embodiment of the present invention. Preferably, the useful and entertaining nature of the present invention makes it especially suitable for use by children, especially during toilet training. Preferably, dispensing paper-roll core system 100 comprises method 1300 comprising the steps of: offering 1301 for sale at least one paper roll 105 having at least one cleanser-releasing soluble core 110 (at least embodying herein offering for sale at least one paper-roll having at least one cleanser-releasing soluble core); and advertising 1302 the availability of such at least one paper roll 105 having at least one cleanser-releasing soluble core 110 to at least one demographic (at least embodying herein advertising the availability of such at least one paper-roll having such at least one cleanser-releasing soluble core to at least one demographic) wherein such at least one demographic substantially comprises persons between about two and about ten years of age (at least embodying herein wherein such at least one demographic substantially comprises persons between about two and about ten years of age), as shown. Upon reading the teachings of this specification, those of ordinary skill in the art will now understand that, under appropriate circumstances, such as user preference, advances in technology, intended use, etc., other steps, such as advertising during children's television programs, providing small specialty toilet paper-rolls, providing single-use toilet paper-rolls, placing child-targeted indicia on the paper-roll, etc., may suffice.

FIG. 14 shows a flow diagram illustrating method 1400 according to a preferred embodiment of the present invention. Preferably, dispensing paper-roll core systems 100 are manufactured with conventional industrial core-making machines with a minimal addition, or no addition, of modified parts. Preferably, conventional industrial core-making machines and processes may be analyzed and then modified to produce dispensing paper-roll core systems 100. Preferably, dispensing paper-roll core system 100 comprises method 1400 comprising the steps of: analyzing 1403 (at least embodying herein analyzing at least one paper-roll core manufacturing machine) at least one paper-roll core manufacturing machine; modifying 1404 (at least embodying herein modifying at least one paper-roll core manufacturing machine to incorporate at least one cleanser into such at least one paper-roll core) at least one paper-roll core manufacturing machine to incorporate at least one cleanser into such at least one paper-roll core wherein such steps of analyzing 1403 and modifying 1404 are economically advantageous over the cost of replacing such at least one paper-roll core manufacturing machine (at least embodying herein wherein such steps of analyzing and modifying are economically advantageous over the cost of replacing such at least one paper-roll core manufacturing machine), as shown.

Preferably, method 1400 further comprises at least one of the steps of: modifying 1405 (at least embodying herein the step of modifying at least one paper-roll core manufacturing machine to incorporate at least one disinfectant into such at least one paper-roll core) at least one paper-roll core manufacturing machine to incorporate at least one disinfectant into such at least one paper-roll core; modifying 1406 (at least embodying herein the step of modifying at least one paper-roll core manufacturing machine to incorporate at least one soluble color into such at least one paper-roll core) at least one paper-roll core manufacturing machine to incorporate at least one soluble color into such at least one paper-roll core; and/or modifying 1407 (at least embodying herein the step of modifying at least one paper-roll core manufacturing machine to incorporate at least one gas-releasing material into such at least one paper-roll core) at least one paper-roll core manufacturing machine to incorporate at least one gas-releasing material into such at least one paper-roll core, as shown. Upon reading the teachings of this specification, those of ordinary skill in the art will now understand that, under appropriate circumstances, such as user preference, advances in technology, intended use, etc., other steps, such as selling modified manufacturing machines, selling modular add-on equipment for the conversions, providing economic analyses of conversion costs, etc., may suffice.

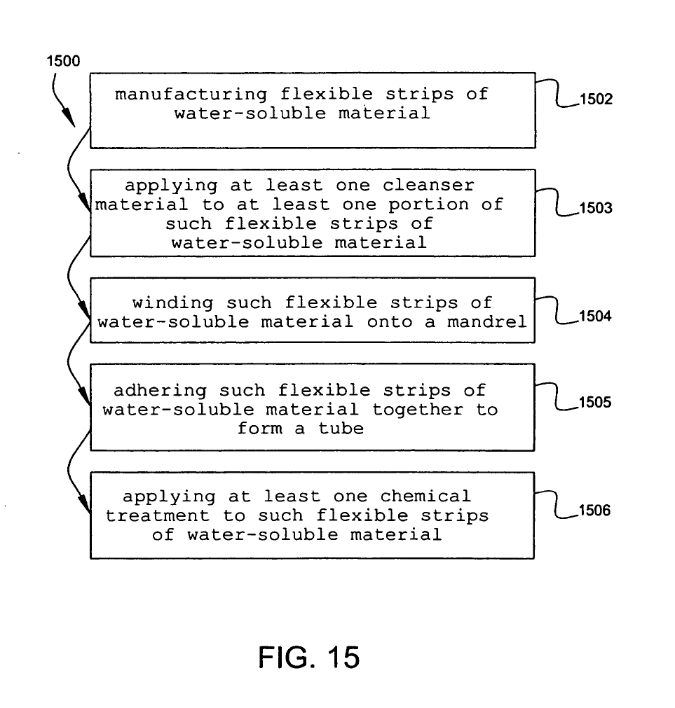

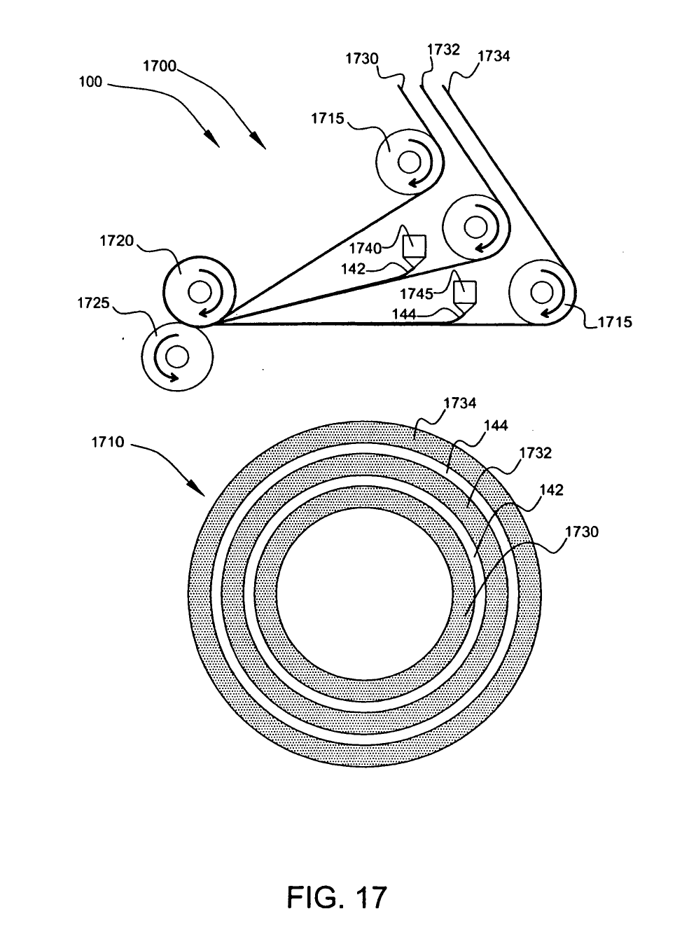

FIG. 15 shows a flow diagram illustrating method 1500 according to a preferred embodiment of the present invention. Preferably, dispensing paper-roll core system 100 comprises method 1500 for manufacturing layered dispensing cores 210, comprising the steps of: manufacturing 1502 (at least embodying herein manufacturing flexible strips of water-soluble material) flexible strips of water-soluble material 130; applying 1503 (at least embodying herein applying at least one cleanser material to at least one portion of such flexible strips of water-soluble material) at least one cleanser material 120 to at least one portion of such flexible strips of water-soluble material 130; winding 1504 (at least embodying herein winding such flexible strips of water-soluble material onto a mandrel) such flexible strips of water-soluble material 130 onto at least one mandrel; and adhering 1505 (at least embodying herein adhering such flexible strips of water-soluble material together to form a tube) such flexible strips of water-soluble material 130 together to form at least one tube. Preferably, method 1500 further comprises the step of applying 1506 (at least embodying herein the step of applying at least one chemical treatment to such flexible strips of water-soluble material) at least one chemical treatment to such flexible strips of water-soluble material 130 (such as, for example, acid 142, base 144, cleanser 145, colorant 148, and/or disinfectant 146 previously discussed), as shown. This method is further illustrated in FIGS. 17-20. Upon reading the teachings of this specification, those of ordinary skill in the art will now understand that, under appropriate circumstances, such as user preference, advances in technology, intended use, economic factors, etc., other steps, such as applying other chemicals and/or materials, manufacturing flexible strips of water-soluble material already containing cleanser and/or other chemicals, purchasing strips of water-soluble material, cutting lengths of the tube, winding paper onto the tube, etc., may suffice.

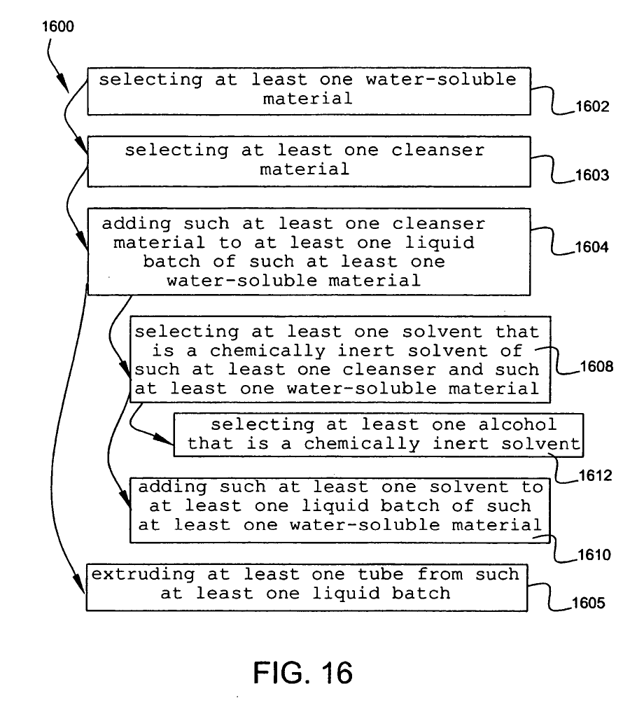

FIG. 16 shows a flow diagram illustrating method 1600 according to a preferred embodiment of the present invention. Preferably, dispensing paper-roll core system 100 comprises method 1600 for manufacturing paper extruded dispensing cores 510 and/or plastic extruded dispensing cores 610, comprising the steps of: selecting 1602 (at least embodying herein selecting at least one water-soluble material) at least one water-soluble material 130; selecting 1603 (at least embodying herein selecting at least one cleanser material) at least one cleanser material 120; adding 1604 (at least embodying herein adding such at least one cleanser material to at least one liquid batch of such at least one water-soluble material) such at least one cleanser material 120 to at least one liquid batch of such at least one water-soluble material 130; and extruding 1605 (at least embodying herein extruding at least one tube from such at least one liquid batch) at least one tube from such at least one liquid batch, as shown. Upon reading the teachings of this specification, those of ordinary skill in the art will now understand that, under appropriate circumstances, such as user preference, advances in technology, intended use, economic factors, etc., other steps, such as adding other chemicals and/or materials to the batch, cutting lengths of the tube, winding paper onto the tube, etc., may suffice.

Preferably, method 1600 further comprises the steps of selecting (step 1608) at least one solvent 1230 that is a chemically inert solvent of such at least one cleanser material 120 and such at least one water-soluble material 130; and adding (step 1610) such at least one solvent 1230 to at least one liquid batch of such at least one water-soluble material 130 (at least embodying herein selecting at least one solvent that is a chemically inert solvent of such at least one cleanser and such at least one water-soluble material; and adding such at least one solvent to at least one liquid batch of such at least one water-soluble material; and at least embodying herein wherein the step of selecting at least one solvent comprises the step of selecting at least one alcohol that is a chemically inert solvent of such at least one cleanser and such at least one water-soluble material).

Preferably, where solvent 1230 is used, the step of selecting (step 1608) at least one solvent 1230 that is a chemically inert solvent of such at least one cleanser material 120 and such at least one water-soluble material 130 further comprises the step of selecting (step 1612) at least one alcohol that is a chemically inert solvent of cleanser material 120 and water-soluble material 130, as shown.

FIG. 17 shows a flow diagram illustrating winder 1700 according to a preferred embodiment of the present invention. Preferably, dispensing paper-roll core system 100 comprises winder 1700 for manufacturing layered dispensing cores 210, as shown. Preferably, three rollers 1715 guide three strips 1730, 1732, and 1734 of water-soluble material 130 toward mandrel 1720 and presser roller 1725, as shown. Preferably, dispenser 1740 applies acid 142, such as, for example, citric acid, to strip 1732, as shown. Preferably, dispenser 1745 applies base 144, such as, for example, sodium bicarbonate, to another strip 1734, as shown. This serves to separate acid 142 from base 144 prior to dissolution. The resulting layered dispensing core 1710 is shown in cross-section. Upon reading the teachings of this specification, those with ordinary skill in the art will now understand that, under appropriate circumstances, considering such issues as advances in technology, user preference, etc., other arrangements, such as other layer orders, other roller placements, other cleaning chemicals, etc., may suffice.

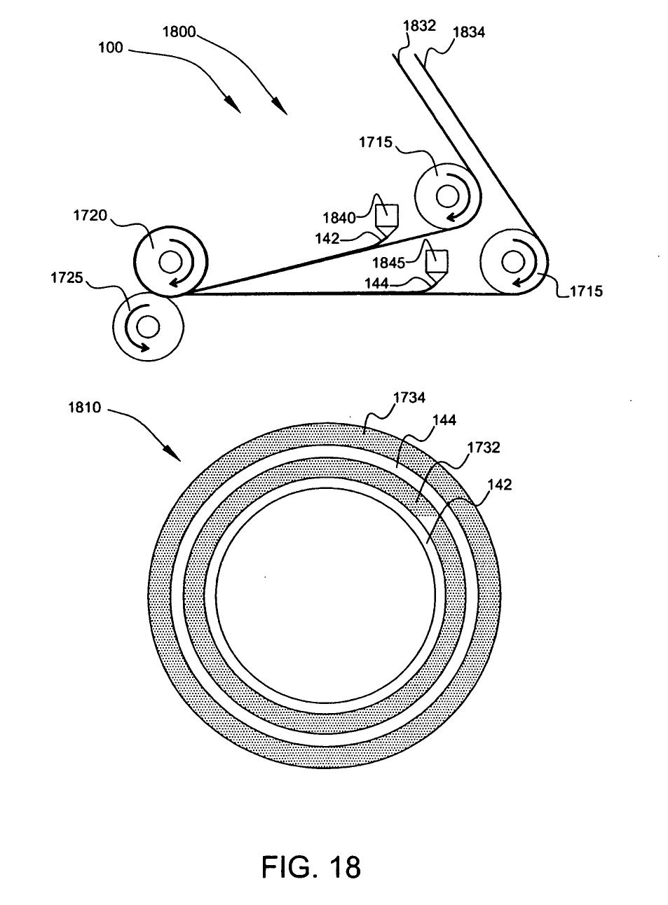

FIG. 18 shows a diagram illustrating winder 1800 according to a preferred embodiment of the present invention. Preferably, dispensing paper-roll core system 100 comprises winder 1800 for manufacturing layered dispensing cores 210, as shown. Preferably, two rollers 1715 guide two strips 1832 and 1834 of water-soluble material 130 toward mandrel 1720 and presser roller 1725, as shown. Preferably, dispenser 1840 applies acid 142, such as, for example, citric acid, to strip 1832, as shown. Preferably, dispenser 1845 applies base 144, such as, for example, sodium bicarbonate, to another strip 1834, as shown. This serves to separate acid 142 from base 144 prior to dissolution. The resulting layered dispensing core 1810 is shown in cross-section. Upon reading the teachings of this specification, those with ordinary skill in the art will now understand that, under appropriate circumstances, considering such issues as advances in technology, user preference, etc., other arrangements, such as other layer orders, other roller placements, other cleaning chemicals, etc., may suffice.

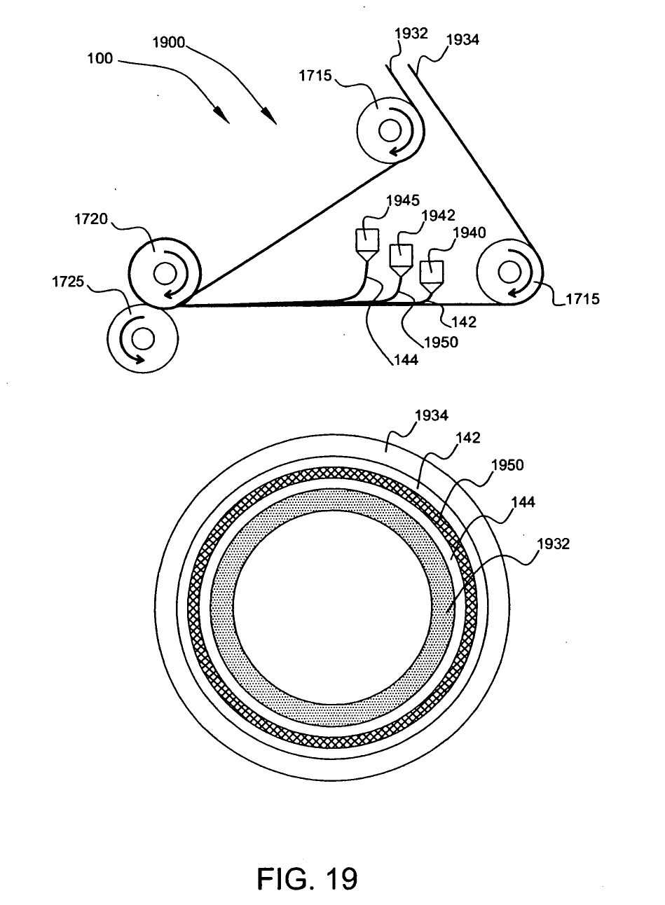

FIG. 19 shows a diagram illustrating winder 1900 according to a preferred embodiment of the present invention. Preferably, dispensing paper-roll core system 100 comprises winder 1900 for manufacturing layered dispensing cores 210, as shown. Preferably, two rollers 1715 guide two strips 1932 and 1934 of water-soluble material 130 toward mandrel 1720 and presser roller 1725, as shown. Preferably, dispenser 1940 applies acid 142, such as, for example, citric acid, to strip 1932, as shown. Preferably, dispenser 1942 applies sealant 1950 over acid 142, as shown. Preferably, dispenser 1945 applies base 144, such as, for example, sodium bicarbonate, to strip 1932 over sealant 1950, as shown. Sealant 1950 serves to separate acid 142 from base 144 prior to dissolution. The resulting layered dispensing core 1910 is shown in cross-section. Upon reading the teachings of this specification, those with ordinary skill in the art will now understand that, under appropriate circumstances, considering such issues as advances in technology, user preference, etc., other arrangements, such as other layer orders, other roller placements, other cleaning chemicals, etc., may suffice.

Preferably, sealant 1950 comprises water-soluble material, such as, for example, polyvinyl alcohol, starch, sugars, polyethylene glycol, etc. Upon reading the teachings of this specification, those with ordinary skill in the art will now understand that, under appropriate circumstances, considering such issues as advances in technology, user preference, chemical compatibility, etc., other water-soluble or water-dispersible sealants, such as other water-soluble films, water-soluble paper, mineral oil, etc., may suffice.

FIG. 20 shows a diagram illustrating winder 2000 according to a preferred embodiment of the present invention. Preferably, dispensing paper-roll core system 100 comprises winder 2000 for manufacturing layered dispensing cores 210, as shown. Preferably, two rollers 1715 guide strip 2030 of water-soluble material 130 toward mandrel 1720 and presser roller 1725, as shown. Preferably, dispenser 2040 applies acid 142, such as, for example, citric acid, to strip 2030, as shown. Preferably, dispenser 2042 applies sealant 1950 over acid 142, as shown. Preferably, dispenser 2045 applies base 144, such as, for example, sodium bicarbonate, to strip 2030 over sealant 1950, as shown. Preferably, dispenser 2043 applies sealant 1950 over base 144, as shown. Preferably, sealant 1950 serves to separate acid 142 from base 144 prior to dissolution, and to protect base 144 from direct contact with the air. The resulting layered dispensing core 2010 is shown in cross-section. Upon reading the teachings of this specification, those with ordinary skill in the art will now understand that, under appropriate circumstances, considering such issues as advances in technology, user preference, chemical compatibility, etc., other water-soluble sealants, such as other water-soluble films, water-soluble paper, mineral oil, etc., may suffice.

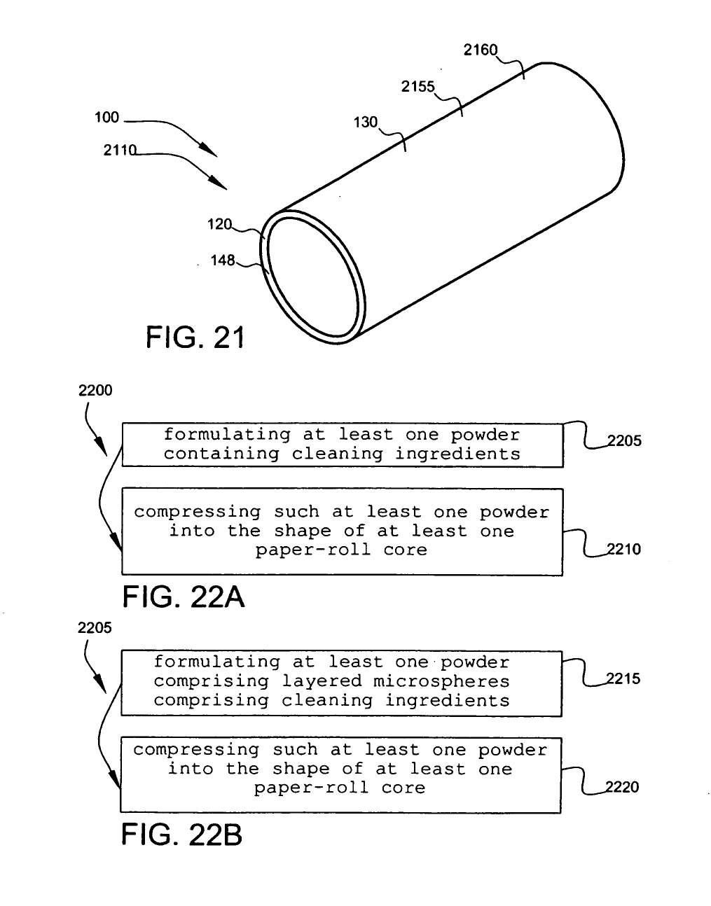

FIG. 21 shows a perspective view illustrating compressed powder dispensing core 2110 having chemicals compressed into a solid tube shape according to a preferred embodiment of the present invention. Preferably, dispensing core 2110 comprises cleaning ingredients 120, as shown. Preferably, dispensing core 2110 comprises binder 2155, as shown. Preferably, dispensing core 2110 comprises lubricant 2160, as shown. Preferably, dispensing core 2110 comprises colorant 148, as shown.

Preferably, binder 2155 (at least embodying herein wherein such at least one soluble paper-roll core comprises at least one binder to bind the ingredients of such at least one soluble paper-roll core together) comprises at least one material capable of assisting adhering other materials together into a solid mass under compression, preferably polyethylene glycol, sorbitol, maltodextrin, other sugars, starch, water-soluble polymers, pectin, etc. Preferably, binder 2155 is used as needed with any dispensing core 110 composition and/or manufacturing process. Upon reading the teachings of this specification, those with ordinary skill in the art will now understand that, under appropriate circumstances, considering such issues as advances in technology, user preference, chemical compatibility, etc., other binders, such as water, alcohol, cellulose, etc., may suffice.

Preferably, lubricant 2160 (at least embodying herein wherein such at least one soluble paper-roll core comprises at least one lubricant to lubricate the ingredients of such at least one soluble paper-roll core during manufacturing processes) comprises a material capable of lubricating the flow of the powdered product through the compression equipment, such as, for example, sodium benzoate, stearates, polyethylene glycol, mineral oil, silicates, alginic acid, etc. Preferably, lubricant 2160 is used as needed with any dispensing core 110 composition and/or manufacturing process. Upon reading the teachings of this specification, those with ordinary skill in the art will now understand that, under appropriate circumstances, considering such issues as advances in technology, user preference, chemical compatibility, etc., other lubricants, such as vegetable oil, glycerin, fats, metal stearates, etc., may suffice.

Preferably, cleaning ingredients 120, lubricant 2160, and binder 2155, and optionally colorant 148, are mixed together as dry powders, and are then compressed in a die into the shape of a tube. This manufacturing method is described for tablet-shaped objects in U.S. Pat. No. 6,713,441 B1, herein incorporated in its entirety by reference. Upon reading the teachings of this specification, those with ordinary skill in the art will now understand that, under appropriate circumstances, considering such issues as advances in technology, user preference, chemical compatibility, etc., other arrangements, such as other ingredients, using a moist powder, etc., may suffice.

In an alternative preferred embodiment, cleaning ingredients 120, particularly acid 142 and base 144, are layered into microspheres, which are then compressed in a die into the shape of a tube. This manufacturing method is described for tablet-shaped objects in U.S. Pat. No. 6,210,711 B1, herein incorporated in its entirety by reference. Upon reading the teachings of this specification, those with ordinary skill in the art will now understand that, under appropriate circumstances, considering such issues as advances in technology, user preference, chemical compatibility, etc., other arrangements, such as other ingredients, using a moist powder, etc., may suffice.

Preferably, cleaning ingredients 120 and colorant 148 are released into water 951 when compressed powder dispensing core 2110 is placed in wet plumbing fixture 101 and dissolves, as shown in FIG. 10.

FIG. 22A shows a diagram illustrating method 2200 according to a preferred embodiment of the present invention. Preferably, dispensing paper-roll core system 100 comprises method 2200 for manufacturing compressed powder dispensing cores 2110, as shown. Preferably, method 2200 comprises the steps of: formulating (step 2205) at least one powder comprising cleaning ingredients 120; and compressing (step 2220) such at least one powder into the shape of at least one paper-roll core (at least embodying herein formulating at least one powder comprising at least one cleanser; and compressing such at least one powder into the shape of at least one paper-roll core), as shown.

FIG. 22B shows a diagram illustrating method 2205 according to a preferred embodiment of the present invention. Preferably, dispensing paper-roll core system 100 comprises method 2205 for manufacturing compressed powder dispensing cores 2110, as shown. Preferably, method 2205 comprises the steps of: formulating (step 2215) at least one powder comprising layered microspheres comprising cleaning ingredients 120; and compressing (step 2220) such at least one powder into the shape of at least one paper-roll core (at least embodying herein formulating at least one powder comprising layered microspheres comprising at least one cleanser; and compressing such at least one powder into the shape of at least one paper-roll core), as shown.

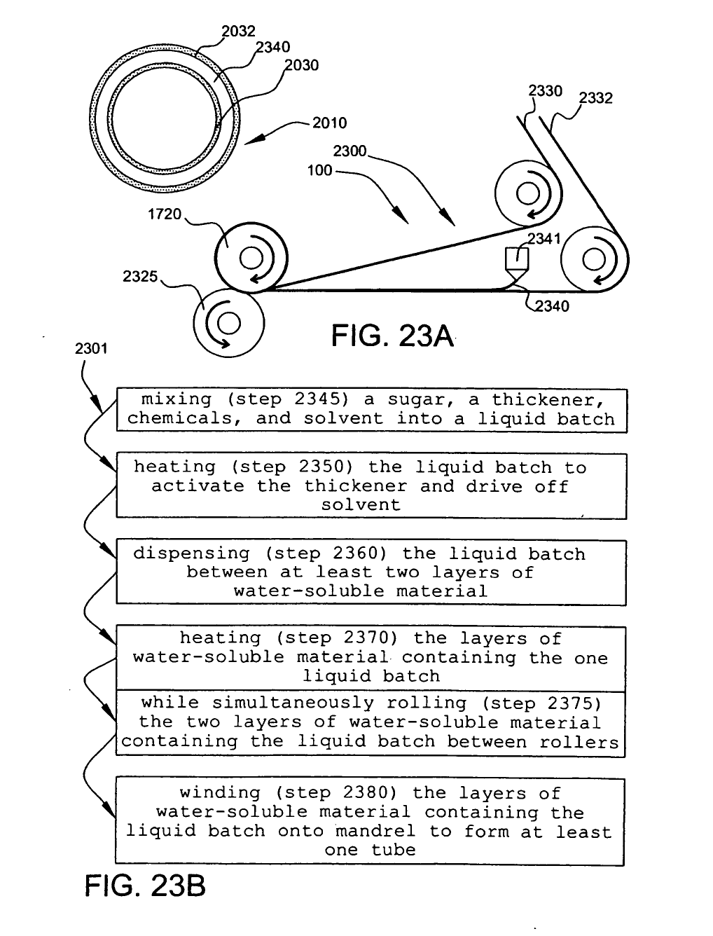

FIG. 23A shows a diagram illustrating winder 2300 and FIG. 23B shows a flow diagram illustrating method 2301 according to a preferred embodiment of the present invention. Preferably, dispensing paper-roll core system 100 comprises winder 2300 for manufacturing layered dispensing cores 2310, as shown. Preferably, chemicals 120 may be mixed with alcohol, sugar, and pectin in vat 1200; then, the mixture is heated to drive off the alcohol and form alcohol-free gel 2340 containing chemicals 120, as shown. Preferably, gel 2340 is then placed between two water-soluble material strips 2330 and 2332 using dispenser 2341, which are then rolled between mandrel 1720 and heated presser roller 2325 to set gel 2340 into a soft, pliable material adhered to and sandwiched between strips 2330 and 2332, as shown. Strips 2330 and 2332 are then wound around mandrel 1720 to form layered dispensing core 2310, as shown. The resulting layered dispensing core 2310 is shown in cross-section.

Preferably, dispensing paper-roll core system 100 comprises method 2301 for manufacturing layered dispensing cores 2310, as shown. Preferably, method 2301 comprises the steps of: mixing (step 2345) sugar, thickener, chemicals 120, and solvent 1230 into a liquid batch; heating (step 2350) the liquid batch to activate the thickener and drive off solvent 1230; dispensing (step 2360) the liquid batch between at least two layers of water-soluble material 130; simultaneously heating (step 2370) the layers of water-soluble material 130 containing the one liquid batch, while rolling (step 2375) the two layers of water-soluble material 130 containing the liquid batch between rollers 2325; and winding (step 2380) the layers of water-soluble material 130 containing the liquid batch onto mandrel 1720 to form at least one tube (at least embodying herein the steps of mixing at least one sugar, at least one thickener, at least one cleanser, and at least one solvent into at least one liquid batch; heating such at least one liquid batch to activate such at least one thickener and drive off such at least one solvent; dispensing such at least one liquid batch between at least two layers of at least one water-soluble material; simultaneously heating such at least two layers of at least one water-soluble material containing such at least one liquid batch, and rolling such at least two layers of at least one water-soluble material containing such at least one liquid batch between at least two rollers; and winding such at least two layers of at least one water-soluble material containing such at least one liquid batch onto at least one mandrel to form at least one tube), as shown. Upon reading the teachings of this specification, those with ordinary skill in the art will now understand that, under appropriate circumstances, considering such issues as advances in technology, user preference, chemical compatibility, etc., other arrangements, such as other chemicals, other thickeners (such as corn starch, pectin activated by monocalcium phosphate, etc.), additional layers, additional heated rollers, etc., may suffice.

The following example provides detailed instructions for making a layered dispensing core 2310 according to method 2301. Without desiring to be bound by theory, this process is believed to be scalable.

### EXAMPLE 1

Equipment—Template Tool—essentially an unwound conventional core—parallelogram shaped; Embossing Tool—an about 0.050″ thick piece of card board matting material with a shape cut out to match the template tool and a paper overlay to protect the hot rollers from any potential squeeze out; Heating Source (stove, hot plate, gas burner, etc.); Hot Roller (Laminator); Tubemaster (1 ¼″ Schedule 40 PVC pipe “mandrel”—1.66″ OD).

Ingredients—8.5×11 sheet of dissolvable paper (Dissolvo—D60), preferably printed with indicia; about 1 TBS (15 ml) Sugar; about 1 TBS (15 ml) Sodium Bicarbonate; about 1 TBS (15 ml) Citric Acid; about ½ tsp (2.5 ml) Powder Detergent; about ¼ tsp (1.25 ml) Pectin (gelling agent); Blue Dye Powder as required; Perfume as required.

Preparation:

1. Premix and sift dry goods Sodium Bicarbonate, Citric Acid, Powder Detergent and Pectin and set aside.
2. Premix a pinch of Blue Dye Powder in 12 oz of water and set aside. (the dye in water is easier to handle than the powder)
3. Using the template tool, fold the paper in half the long ways and mark the zone on the inner surface of the folded dissolvable paper where the “candy” will be applied.
4. Mix 1 TBS Sugar and ½ tsp Blue Dye and Water mixture in a small cooking pan (step 2345). (If using a water based perfume, add it here)
5. Cook on high heat over electric or gas stove stirring constantly (step 2350).
6. Monitor temperature of the sugar using a candy thermometer or digital thermometer with a thermocouple.
7. Choose the temperature at which the desired firmness of the “candy” is required to yield the desired product stiffness. (see candy temperatures listed below, preferably 240° F.—Soft Ball)
8. Once the sugar reaches the desired temperature, mix in the dry goods to a well distributed consistency. (If using a non-water based perfume, add it here)
9. Spread the “candy” onto the paper in the zone delineated by the template tool (step 2360).
10. Fold the paper in half the long ways
11. A hand roller may be used to flatten out any large clumps of material prior to running through the hot rollers.
12. Place the folded paper with the “candy” (Sandwich) into the embossing tool aligned with the registration marks.
13. Run the embossing tool through the hot rollers as many times as required until the marked template zone is completely filled (step 2370 and step 2375).
14. Remove the Sandwich from the embossing tool.
15. Net trim the Sandwich at the template tool outline.
16. Roll the Sandwich onto the Tubemaster mandrel to create a helically wound tube (step 2380).
17. Some manipulation of the joint (lap joint) may be required to get an aesthetically acceptable tube.
18. Roll the tube on the mandrel (like a rolling pin) on a hard surface for best uniformity.

### EXAMPLE 2

Equipment—1 quart or smaller saucepan; 1 quart bowl; Wisk and/or Sifter; Metal Spatula; Gas or Electric stove; Digital Thermometer; Laminator; Laminator Picture Frame Tool (Embossing Tool); Template Tool; Mandrel (Tubemaster 1000, 2000 or 3000).

Ingredients—Sugar Granules; sucrose; table sugar; Citric Acid Granules; Sodium Bicarbonate Powder; Fruit Pectin, (Sure Gel); Dry Soap Powder, laundry detergent; Blue Dye Powder (food grade); and Water.

Procedure:

1. Mix dry goods in separate bowl in the following quantities:
a. 1 TBSP Citric Acid
2. 1 TBSP Sodium Bicarbonate
3. ¼ tsp Pectin
4. ¼ tsp Dry Soap
5. Prepare a 12 oz bottle of water with a pinch of Blue Dye and shake well.
6. Mix 1 TBSP Sugar with ½ tsp Blue Water in the saucepan.
7. Heat the mixture slowly until boiling (212° F.-215° F.).
8. Boil and continuously stir while monitoring the temperature using the digital thermometer.
9. Keep boiling until the rate of bubbling is minimized. This is the time that the water is nearly outgassed from the melted sugar “syrup”.
10. Record final temperature. Preferred target temperature 240° F. (soft ball).
11. Add the pre-mixed dry goods.
12. Stir into a paste or dough consistency.
13. Apply the paste to Dissolvo paper prepared by marking the cutout zone using the Template tool and folding the paper in half the long ways.
14. Run through the laminator as many times as required to fill the cutout zone as drawn out by the Template Tool.
15. Remove tube flat pattern from Picture Frame Tool.
16. Net trim tube flat pattern to the Template Tool markings
17. Roll onto mandrel and apply breather caul as required.
18. Let tube set until cool.
   The resulting core dissolved to a flushable state within 30 seconds and was totally dissolved in about 2 minutes.

### EXAMPLE 3

Equipment—1 quart or smaller saucepan; 1 quart bowl; Wisk and/or Sifter; Metal Spatula; Gas or Electric stove; Digital Thermometer; Laminator; Laminator Picture Frame Tool (Embossing Tool); Template Tool; Mandrel (Tubemaster 1000, 2000 or 3000); Stopwatch.

Ingredients—Sugar Granules, sucrose, table sugar; Citric Acid Granules; Sodium Bicarbonate Powder; Blue Dye Powder, food grade; Water.

Procedure:

1. Mix dry goods in separate bowl in the following quantities:

a. 1 TBSP Citric Acid

b. 1 TBSP Sodium Bicarbonate
2. Prepare a 12 oz bottle of water with a pinch of Blue Dye and shake well.
3. Mix 1 TBSP Sugar with ½ tsp Blue Water in the saucepan.
4. Heat the mixture slowly until boiling (212° F.-215° F.).
5. Boil and continuously stir while monitoring the temperature using the digital thermometer.
6. Keep boiling until the rate of bubbling is minimized. This is the time that the water is nearly out-gassed from the melted sugar “syrup”.
7. Record final temperature. Preferred target temperature 240° F. (soft ball). Add the pre-mixed dry goods.
8. Stir into a paste or dough consistency.
9. Apply the paste to Dissolvo paper prepared by marking the cutout zone using the Template tool and folding the paper in half the long ways.
10. Run through the laminator as many times as required to fill the cutout zone as drawn out by the Template Tool.
11. Remove tube flat pattern from Picture Frame Tool.
12. Net trim tube flat pattern to the Template Tool markings
13. Roll onto mandrel and apply breather caul as required.
14. Let tube set until cool.

The resulting core dissolved to a flushable state within 30 seconds and was totally dissolved in about 2 minutes.

Mixing the dry goods into the molten sugar allows water-soluble chemicals (i.e. citric acid, sodium bicarbonate, and powdered detergents) to be incorporated into the sugar matrix without dissolving. Since the chemicals do not dissolve, they do not generally react with each other in the sugar matrix. In addition to using the sugar matrix in the paper-layering manufacturing process shown above, the chemical-laden sugar matrix can alternatively be extruded as a finished tube, or as a ribbon to be wound into a tube on a mandrel, preferably without dissolvable paper layers. This provides a simple and inexpensive method of manufacturing.

FIG. 23D shows a chart illustrating crush height data collected for conventional roll cores vs. layered dispensing cores 2310 made according to method 3201. Preferably, layered dispensing cores 2310 are sufficiently strong to withstand suggested manufacturing processes and ordinary use.

FIG. 23E shows a chart illustrating deflection data for conventional roll cores vs. layered dispensing cores 2310 made according to method 3201. Preferably, layered dispensing cores 2310 are sufficiently resilient to withstand ordinary use and avoid crumbling.

FIG. 23F shows a chart illustrating crippling data for conventional roll cores vs. layered dispensing cores 2310 made according to method 3201. Preferably, layered dispensing cores 2310 are sufficiently strong to withstand ordinary use and avoid crippling (lengthwise crushing deformation).

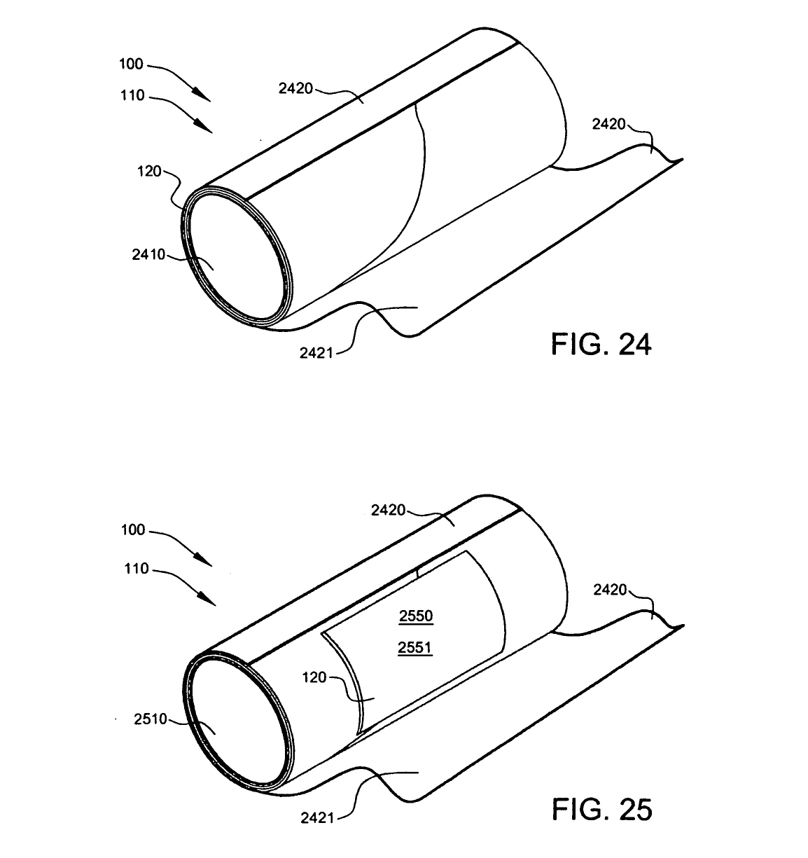

FIG. 24 shows a perspective view illustrating dispensing core 2410 having removable cover 2420 according to a preferred embodiment of the present invention. Preferably, dispensing core 110 comprises dispensing core 2410, as shown. Preferably, dispensing core 2410 comprises removable cover 2420, as shown. Preferably, removable cover 2420 provides a barrier between chemicals 120 and paper roll 105. Preferably, removable cover 2420 is removed by the user prior to placing dispensing core 2410 into plumbing fixture 101. Preferably, removable cover 2420 comprises plastic film which is attached to dispensing core 2410 with adhesive 2421, as shown. Preferably, removable cover 2420 (at least embodying herein wherein said at least one soluble paper-roll core further comprises at least one manually-removable outer layer) comprises indicia 710.

FIG. 25 shows a perspective view illustrating dispensing core 2510 having at least one patch 2550 of cleaning chemicals 120 according to a preferred embodiment of the present invention. Preferably, dispensing core 2510 comprises patch 2550 of cleaning ingredients 120, as shown. Preferably, patch 2550 comprises cleaning ingredients 120 applied to at least one portion of the interior and/or exterior surface of dispensing core 2510, as shown. Preferably, patch 2550 is covered with removable cover 2420 to prevent cleaning ingredients 120 from contacting paper roll 105, as shown. Preferably, removable cover 2420 comprises plastic film. More preferably, removable cover 2420 comprises water-soluble plastic film.

Preferably, patch 2250 comprises self-contained packet 2251 adhered to the interior and/or exterior surface of dispensing core 2510, as shown. Preferably, self-contained packet 2251 is water-soluble. Preferably, self-contained packet 2251 is removable for placement into plumbing fixture 101 separately from the rest of dispensing core 2510. Upon reading the teachings of this specification, those with ordinary skill in the art will now understand that, under appropriate circumstances, considering such issues as advances in technology, user preference, etc., other arrangements, such as multiple packets, the packet comprises an advertising sample of material, the packet containing some chemicals and the core containing other chemicals, etc., may suffice.

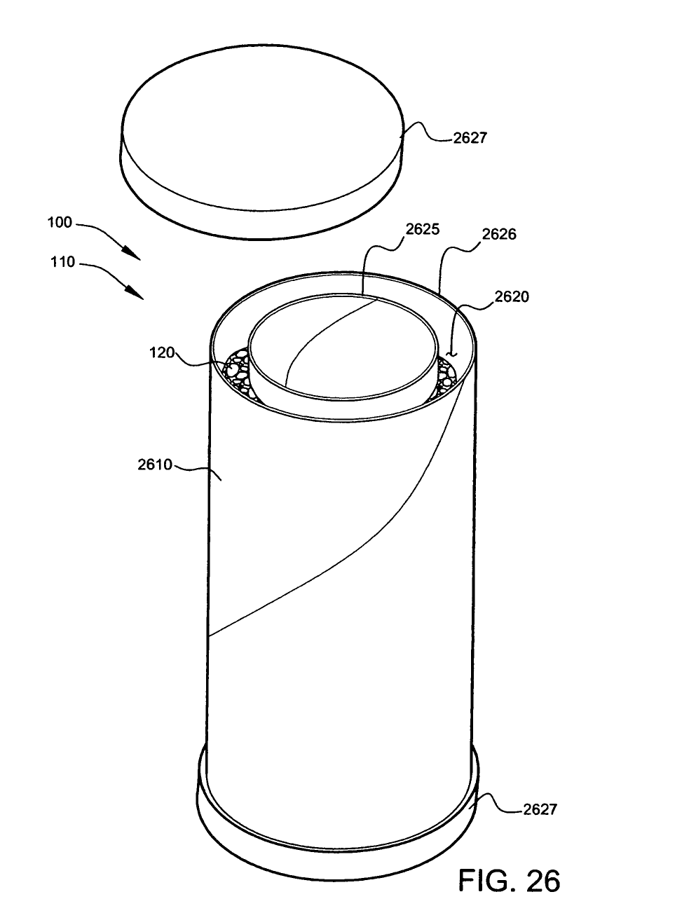

FIG. 26 shows a perspective view illustrating dispensing core 2610 according to a preferred embodiment of the present invention. Preferably, dispensing core 110 comprises dispensing core 2610, as shown. Preferably, dispensing core 2610 comprises at least one hollow chamber 2620 adapted to hold chemicals, as shown, preferably cleaning ingredients 120. Preferably, dispensing core 2620 comprises inner core 2625, outer core 2626, and end caps 2627, as shown. Preferably, cleaning ingredients 120 are placed between inner core 2625 and outer core 2626, sealed with end caps 2627, as shown. Preferably, the user removes one end cap 2627 and pours cleaning ingredients 120 into plumbing fixture 101. More preferably, inner core 2625, outer core 2626, and end caps 2627 comprise water-soluble material 130, allowing dispensing core 2610 to be placed in plumbing fixture 101 to dissolve. Upon reading the teachings of this specification, those with ordinary skill in the art will now understand that, under appropriate circumstances, considering such issues as advances in technology, user preference, etc., other arrangements, such as other chamber shapes, other numbers of chambers, other chamber sealing methods, etc., may suffice.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and/or values disclosed herein are not to be understood as being strictly limited to the exact dimension and/or numerical value recited. Instead, unless otherwise specified, each such dimension and/or numerical value is intended to mean both the recited dimension and/or numerical value and a functionally equivalent range surrounding that dimension and/or numerical value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A core for use with a convolutely wound material, said core comprising:
a water-soluble support material;
a cleanser disposed upon said water-soluble support material, said cleanser further comprising an acid and a base; and,
wherein said core is soluble upon contact with water and said cleanser is disposable within said water upon initiation of said solubilization of said core.

2. The core of claim 1 further comprising a fragrance.

3. The core of claim 2 wherein said fragrance is detectable by a user prior to solubilization of said core.

4. The core of claim 2 wherein said fragrance 350 detectable by a user after during solubilization of said core.

5. The core of claim 1 further comprising a colorant.

6. The core of claim 1 wherein said cleanser is disposed upon said water-soluble support material in at least one layer.

7. The core of claim 6 wherein said acid is disposed in at least one of said layers disposed upon said water-soluble support material.

8. A core for use with a convolutely wound material, said core comprising:
a water-soluble support material;
a cleanser disposed upon said water-soluble support material, said cleanser further comprising an acid and a base;
a binder material, said binder material providing adhesion of at least one of said acid and said base of said cleanser to said water-soluble support material; and,
wherein said core is soluble upon contact with water and said cleanser is disposable within said water upon initiation of said solubilization of said core.

9. The core of claim 8 wherein said acid is selected from the group consisting of citric acid, boric acid, hydrochloric acid, hydroxyacetic acid, acetic acid, fumaric acid, sulfuric acid, hydrogen peroxide, and combinations thereof.

10. The core of claim 8 wherein said base is selected from the group consisting of calcium carbonate, sodium carbonate, potassium carbonate, potassium hydroxide, sodium hydroxide, ammonia, and combinations thereof.

11. The core of claim 8 further comprising a bleach.

12. The core of claim 11 wherein said bleach is selected from the group consisting of cyanuric acid, trichloroisocyanuric acid, sodium percarbonate, sodium dichloroisocyanurate, 1-Bromo-3-Chloro-5, 5-Dimethylhydantoin, peroxide, sodium hypochlorite, and combinations thereof.

13. The core of claim 8 further comprising a disinfectant.

14. The core of claim 13 wherein said disinfectant is selected from the group consisting of pine oil, isopropyl alcohol, Octyl decyl dimethyl ammonium chloride, Dioctyl dimethyl ammonium chloride, Didecyl dimethyl ammonium chloride, Alkyl dimethyl benzyl ammonium chlorides, 2-butoxyethanol, bleach, thymol, eucalyptol, menthol, alcohols, oxidizers, iodine compounds, silver compounds, phenolic compounds, quaternary ammonium compounds, and combinations thereof.

15. The core of claim 8 further comprising a fragrance.

16. The core of claim 8 further comprising a colorant.

17. The core of claim 8 further comprising a lubricant.

18. The core of claim 8 further comprising a surfactant.

19. The core of claim 19 wherein said surfactant is selected from the group consisting of sodium laureth sulfate, sodium lauryl sulfate, tetrasodium pyrophosphate, anionic surfactants, wetting agents, sodium borate, and/or tetrasodium EDTA, soaps, alkyl glucosides, ammonium lauryl sulfate, sodium stearate, dialkylmethylamines, and combinations thereof.

20. The core of claim 8 further comprising an encapsulant.
